(19) United States
(12) Patent Application Publication
(10) Pub. No.: US 2009/0197765 A1
(43) Pub. Date: Aug. 6, 2009

(54) SOLID FORMULATION OF LOW MELTING ACTIVE COMPOUND

(75) Inventors: Jesse H. Gaytan, Valdosta, GA (US); C. Stephen Seckinger, Valdosta, GA (US); Osborn J. Turner, IV, Olive Branch, MS (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Arysta Lifescience North America, LLC

(21) Appl. No.: 12/365,577

(22) Filed: Feb. 4, 2009

Related U.S. Application Data
(60) Provisional application No. 61/026,328, filed on Feb. 5, 2008.

(51) Int. Cl. A01N 43/40

(52) U.S. Cl. 504/130; 504/255

(57) ABSTRACT

The present invention is directed to solid formulations comprising a low melting active compound. The solid formulations particularly can comprise pesticidal low melting compound, including herbicides, such as fluroxypyr and derivatives thereof. The invention further provides methods of preparing the formulations and methods of plant treatment using the solid formulations.

### CROSS-REFERENCE TO RELATED APPLICATIONS

The present application claims priority to U.S. Provisional Patent Application No. 61/026,328, filed Feb. 5, 2008, which is incorporated herein by reference in its entirety for all purposes.

### FIELD OF THE INVENTION

The present invention relates to solid formulations of low melting active compounds. More particularly, the invention relates to solid formulations comprising pesticidally active low melting compounds, including herbicides, such as fluroxypyr.

### BACKGROUND OF THE INVENTION

Pesticidally active compounds are often provided in mixtures, or formulations, designed to facilitate the usefulness of the active compound. Pesticidal formulations can generally be classified based upon the physical state of the formulation and/or the mode by which the formulation can be applied to a crop or a crop planting site. For example, pesticidal formulations may exist as liquid formulations or solid formulations, and these may be even further sub-divided. For example, liquid pesticidal formulations may be in the form of: solutions (e.g., mixtures of two or more liquid substances, such as liquid active compound and a liquid carrier); emulsifiable concentrates (e.g., an active compound solubilized in an emulsifying agent that will mix with water); and flowable suspensions (e.g., an active compound mixed with solid carrier or diluent and suspended in water to form a slurry that will mix in water). Examples of solid pesticidal formulations include wettable powders (e.g., an active compound combined with an inert carrier, such as clay, in a finely divided form) and extruded granules (e.g., an active compound mixed with diluents and other components and extruded to form pellets or granules).

Choice of pesticidal formulation can be based upon a number of considerations for increasing the usefulness of the formulation, including: ease of application at the treatment site; ease of handling and transportation; effectiveness of the active compound in the formulation; safe handling of the composition; evenness of distribution at the treatment site; and controlling drift and volatility. Solid formulations are often a preferred type of formulation because solid formulations provide multiple advantages in relation to the above considerations. For example, solid formulations are typically easy to ship, store, and handle, particularly in granule or pellet form. Moreover, solid formulations are often easier to use (i.e., apply to a treatment site) because they rarely require complex mixing, such as may be needed with liquid formulations.

In some instances, the ability to formulate certain active compounds may be restricted by physical and/or chemical properties of the active compounds themselves. For example, many active compounds are formulated as liquids because the low melting point of the active compounds makes it excessively difficult, or even impossible, to formulate a stable, effective solid formulation. The present invention provides solid formulations of low melting active compounds, particularly compounds that have previously been limited to use in liquid formulations.

### BRIEF SUMMARY OF THE INVENTION

In one aspect, the invention provides a solid formulation comprising a low melting active compound. In some embodiments, the solid formulation comprises a low melting active compound, a free-flow agent, and a diluent. In specific embodiments, the low melting active compound is a pesticidally active compound, particularly a herbicidally active compound, such as fluroxypyr acid or ester. The individual components of the solid formulation may be present in defined amounts. For example, the solid formulation may comprise about 10% by weight to about 70% by weight of the low melting active compound. The solid formulation may comprise about 2% to about 15% by weight of the free-flow agent. The solid formulation may comprise about 30% by weight to about 80% by weight of the solid diluent. In specific embodiments, the free-flow agent comprises a silica-containing material, particularly hydrophobic silicon dioxide. In particular embodiments, the low melting active compound is in a particulate form (e.g., crystalline form or particulate amorphous form) and the free-flow agent is in particulate form. The particles of the low melting active compound particularly may be impregnated with the free-flow agent particles. Preferably, the free-flow agent particles substantially completely coat the particles of the low melting active compound and thereby form a coating thereon.

In addition to the components noted above, the solid herbicidal formulation of the invention can comprise various further components useful for facilitating formation of the solid material and/or useful for imparting various properties to the solid material for use in plant treatment methods. Preferably, the formulation comprises one or more compounds useful for facilitating formation of a solid formulation. Such additional compounds can be selected from, for examples, dispersants, wetting agents, binding agents, anti-foam agents, and pH adjusters.

In one embodiment, the present invention provides a solid formulation comprising a low melting active compound in particulate form, a free-flow agent in particulate form, and a solid diluent. In particular, particles of the low melting active compound can be impregnated with the free-flow agent particles. Moreover, the solid formulation can be prepared to have a moisture content of less than about 5% by weight. The low melting active and the free-flow agent can be present in a defined weight:weight ratio, such as about 7:1 to about 3:1. The solid formulation may comprise one or more additional active compounds, which specifically may be pesticidally active compounds.

In a specific embodiment, the present invention is directed to a solid formulation comprising: (a) about 10% by weight to about 70% by weight of a low melting active compound; (b) about 2% by weight to about 15% by weight of a free-flow agent; (c) about 10% by weight to about 80% by weight of a diluent; (d) about 2% by weight to about 25% by weight of a dispersant; (e) about 1% by weight to about 15% by weight of a binding agent; (f) about 0.1% by weight to about 5% by weight of a pH adjuster; (g) up to about 5% by weight of a wetting agent; and (h) up to about 5% by weight of an anti-foam agent. The solid formulation particularly can be in the form of a granule having a moisture content of less than about 5% by weight.

In another aspect, the present invention also provides methods of preparing the solid herbicidal formulations described herein. The method is particularly beneficial in that it allows for formation a solid material using active compounds that have traditionally been restricted to liquid formulations because of their low melting temperature.

In one embodiment, the method of the invention comprises the following steps: a) binding the herbicidally active compound to a free-flow agent; b) combining the bound fluroxypyr with a diluent and one or more formulation adjuvants to form a homogeneous mixture; c) milling the homogeneous mixture to form particles; d) kneading the particles in the presence of a moisture-providing agent to form an extrudable mix; and e) shaping the mix to form the solid herbicidal formulation.

In another embodiment, the method of the invention comprises the following steps: a) mixing the low melting active compound in particulate form with a free-flow agent in particulate form under high shear or impact to impregnate particles of the low melting active compound with the particles of the free-flow agent to form bound particles of the low melting active compound and the free-flow agent; b) combining the bound particles of the low melting active compound and the free-flow agent with a diluent and one or more formulation adjuvants to form a homogeneous mixture; c) milling the homogeneous mixture to form particles; and d) further processing the particles to be in a solid delivery form. The mixing step a) particularly can comprise blending the low melting active and the free-flow agent and feeding the blended material through a mill apparatus, such as a hammer mill. In specific embodiments, it is notable that the entire content of the free-flow agent used in preparing the solid formulation is provided in mixing step a).

In a specific embodiment, the method of the invention comprises the following steps: a) mixing about 10% by weight to about 70% by weight of a low melting active compound in particulate form with about 2% by weight to about 15% by weight of a free-flow agent in particulate form under high shear or impact to impregnate particles of the low melting active compound with the particles of the free-flow agent to form bound particles of the low melting active compound and the silicon dioxide; b) combining the bound particles of the low melting active compound and the free-flow agent with about 10% by weight to about 80% by weight of a diluent, about 2% by weight to about 25% by weight of a dispersant, about 1% by weight to about 15% by weight of a binding agent, about 0.1% by weight to about 5% by weight of a pH adjuster, and up to about 5% by weight of a wetting agent to form a homogeneous mixture; c) milling the homogeneous mixture to form particles; and d) further processing the particles with up to about 5% by weight of an anti-foam agent to be in a solid delivery form. All of the percentages are based on the final weight of the overall solid formulation.

According to another aspect, the invention also comprises mixtures of pesticidal granules. In one embodiment, the invention is directed to a mixture comprising two or more groups of different solid pesticidal granules, wherein one of the groups comprises a solid formulation of a low melting active compound, as described herein. The other group(s) of solid pesticidal granules can comprise a pesticide that is different from low melting active compound.

In a further aspect, the present invention also provides various treatment methods using solid formulations of low melting active compounds. For example, in one embodiment, the present invention provides a method of controlling unwanted pests at a locus. In particular, the method can comprise applying to the locus a pesticidally active compound wherein, prior to application, the pesticidally active compound is in the form of a solid agricultural composition as described herein. Because the low melting active compounds are provided in a solid delivery form, the methods of the invention provide a much simplified mode of application of the low melting active compound. Thus, the solid compositions can be used in methods including application to a variety of sites. For example, the solid formulations of the low melting active compounds can be used in various agriculture and forestry applications, can be applied to right-of-ways and roadsides, can be used in aquaculture as well as vegetation management, can be applied to turf and ornamental plants, and can be used on crop land, non-crop land as well as in personal home and garden applications. Of course, the foregoing is only a representative example of the numerous uses of the solid formulations of the invention, all of which are encompassed by the present disclosure.

### BRIEF DESCRIPTION OF THE DRAWINGS

Having thus described the invention in general terms, reference will now be made to the accompanying drawings, which are not necessarily drawn to scale, and wherein

FIG. 1 is a micrograph image of a fluroxypyr crystal;

FIG. 2 is a micrograph image of silicon dioxide particles;

FIG. 3 is a micrograph image of a fluroxypyr crystal coated with silicon dioxide particles after high shear mixing of fluroxypyr crystals and silicon dioxide particles to facilitate embedding of the silica particles into the fluroxypyr crystals

FIG. 4 is a graph illustrating control of kochia weed using a 40% WDG fluroxypyr formulation according to the invention, with or without various additives, or a known liquid emulsifiable concentrate fluroxypyr formulation;

FIG. 5 is a graph illustrating control of buckwheat weed using a 40% WDG fluroxypyr formulation according to the invention, with or without various additives, or a known liquid emulsifiable concentrate fluroxypyr formulation;

FIG. 6 is a graph illustrating control of thistle weed using a 40% WDG fluroxypyr formulation according to the invention, with or without various additives, or a known liquid emulsifiable concentrate fluroxypyr formulation; and

FIG. 7 is a graph illustrating control of flax weed using a 40% WDG fluroxypyr formulation according to the invention, with or without various additives, or a known liquid emulsifiable concentrate fluroxypyr formulation.

### DETAILED DESCRIPTION OF THE INVENTION

The present invention now will be described more fully hereinafter through reference to various embodiments. These embodiments are provided so that this disclosure will be thorough and complete, and will fully convey the scope of the invention to those skilled in the art. Indeed, the invention may be embodied in many different forms and should not be construed as limited to the embodiments set forth herein; rather, these embodiments are provided so that this disclosure will satisfy applicable legal requirements. As used in the specification, and in the appended claims, the singular forms “a”, “an”, “the”, include plural referents unless the context clearly dictates otherwise.

A noted above, many types of active compounds are only capable of being formulated in a liquid state. The present invention allows for such active compounds to be formulated in a solid state, such as granules, pellets, and the like. The herbicide fluroxypyr is one example.

Fluroxypyr (4-amino-3,5-dichloro-6-fluoro-2-pyridyloxyacetic acid) is known to be a compound that exhibits herbicidal activity and is used as such in a variety of liquid herbicidal formulations. In such formulations, fluroxypyr is typically provided in the form of an ester, such as the butoxy-methylethyl (butometyl) or methylheptyl (meptyl) esters. Such esters exhibit good solubility in organic solvents. Accordingly heretofore known formulations of fluroxypyr have been prepared as liquid formulations. For example, HURLER® (Barclay Plant Protection) is an emulsifiable liquid concentrate consisting of 20.6% by weight fluroxypyr-meptyl and the balance surfactants and solvents. CLEANWAVE® (Dow AgroSciences) is a liquid formulation consisting of 20.2% by weight fluroxypyr-meptyl, 1.9% by weight aminopryalid triisopropanolammonium, and 77.9% by weight aromatic solvent (including naphthalene) and dipropylene glycol methyl ether. STARANE® (Dow AgroSciences) is a liquid formulation consisting of 26.2% by weight fluroxypyr-meptyl and 73.8% by weight inert ingredients, including 1-methyl-2-pyrrolidone and petroleum solvent (including naphthalene). TOMAHAWK® (Makhteshim-Agan Ltd.) is a liquid formulation consisting of 28-31% by weight fluroxypyr-meptyl and 60-65% by weight aromatic solvent (include naphthalene).

Although liquid formulations of low melting active compounds, such as fluroxypyr, are known, it is desirable to have solid formulations comprising active compounds having a low melting point. Many factors play a part in the ability to provide an active compound in a specific form or composition. For example, aging stability and suspensability of solid formulations, such as wettable powders (WP) and wettable dry granules (WG or WDG), typically requires a small dispersed particle size containing the active ingredient. Achieving this rather small particle size may require formulation particle size reduction (e.g., grinding), by hammer mill, media mill, air mill, and combinations thereof and the like. When using active compounds having a relatively low melting temperature, typically less than about 100° C. at normal atmospheric pressure, direct grinding (as in the art) of the discrete solid active compound can be difficult due to melting or softening of the active itself during that grinding.

The present invention overcomes limitations in the art by providing dry, solid formulations comprising active compounds, particularly pesticides, and further particularly herbicides (such as fluroxypyr acid and esters). This is highly advantageous since the solid formulation increases ease of storing, shipping, and handling of the formulated active compound. Moreover, the solid formulation of the invention is advantageous since it can easily be mixed with other formulations that are provided in the solid form. In particular, it is common for certain pesticides to have favored mixing partners (i.e., other pesticides that, when combined, provide favorable effects). As used herein, the term pesticide is intended to included acaracides (or miticides), algicides, avicides, bactericides, fungicides, herbicides, insecticides, molluscicides, nematicides, rodenticides, and virucides.

In one aspect, the invention provides a solid formulation comprising an active compound that has a low melting point. Such compounds are referred to herein as “low melting compounds,” which is a term recognized in the relevant art, particularly in the field of pesticidal compositions. In particular, a low melting active compound according to the present invention is a compound that has a melting point of less than about 100° C., less than about 90° C., less than about 85° C., less than about 80° C., less than about 75° C., or less than about 70° C. In certain embodiments, a low melting compound according to the invention is a compound with a melting point in the range of about 20° C. to about 100° C. In specific embodiments, a low melting compound is a compound that has a melting point in the range of about 25° C. to about 100° C., about 30° C. to about 100° C., about 30° C. to about 90° C., about 30° C. to about 80° C., about 30° C. to about 70° C., about 40° C. to about 90° C., about 40° C. to about 80° C., about 50° C. to about 90° C., about 50° C. to about 80° C., or about 50° C. to about 70° C.

Any active compound that is a low melting compound, as described above, may be used in a formulation according to the present invention. In particular, the present invention encompasses any pesticidally active low melting compound, including low melting acaracides (or miticides), low melting algicides, low melting avicides, low melting bactericides, low melting fungicides, low melting herbicides, low melting insecticides, low melting molluscicides, low melting nematicides, low melting rodenticides, and low melting virucides.

Low melting compounds useful according to the invention can include any low melting compound from the group of compounds including acetanilides, amides, amidines, anilides, arylaminopropionic acids, arylalanines, aryloxycarboxylic acids, aryloxyplenoxypropionates (“fops”), azoryls, benzilates, benzofurans, benzoic acids, benzoylcyclohexanediones, benzofuranyl alkylsulfonates, benzothiazoles, benzoxazoles, benzoylpyrazoles, bipyridyliums, carbamates, carbanilates, carboxamides, chloroacetamides, chloroacetanilides, chlorotriazines, cyclodienes, cyclohexanediones (“dims”), cyclohexane oximes, cyclopropylisoxazoles, dicarboximides, dinitroalilines, dinitrophenols, diphenyl ethers, dithiocarbamates, dithiolanes, glycines, halogenated aliphatics, imidazoles, imidazolinones, isoazolidinones, methoxytriazines, methylthiotriazines, neonicotinoids, nitriles, nitroanilines, nitrophenylethers, N-phenylphthalimides, organoarsenicals, organophosphates, organophosphorus, oxadiazines, oxadiazolinones, oxazoles, oxyacetamides, phenoxyalkanoic acids, phenyl carbamates, ureas, phenoxys (including substituted phenoxys), phenoxyacetics, phenoxybutyrics, phenoxycarboxylic acids, phenoxypropionics, phenylamides, phenylethylenediamines, phenylpyrazoles, phenylpyridazines, phenylureas, phosphinic acids, phosphorodithioates, phthalic acids, picolinic acids, pyrazoles, pyrethroids, pyridazines, pyridazinones, pyridines, pyridine carboxylic acids, pyrimidinamines, pyrimidinyloxybenzoic acids, pyrimidinylthiobenzoic acids, quaternary ammoniums, quinazolinones, quinoline carboxylic acids, strobilurins, sulfonamides, sulfonanilides, sulfonylaminocarbonyltriazolinones, sulfonylureas, tetrazolinones, thiadiazoles, thiadiazolylureas, thiocarbamates, thiocarbonates, thioureas, triazines, triazoles, triazolones, triazinones, triazolopyrimidines, triketones, uracils, and ureas (including substituted ureas). Of course, the invention is not limited to compounds from the above classes, and any low melting compound could be used.

Specific, non-limiting examples of low melting compounds that are useful according to the invention include the following: acephate, acequinocyl, acetochlor, aclonifen, acrinathrin, alachlor, alanycarb, aldrin, amitraz, ametryn, anilofos, azamethiphos, azinphos, beflubutamid, benalaxyl, benfluralin, benfuresate, bensulide, bensultap, benzoximate, bifenox, bifenthrin, binapacryl, biphenyl, bromopropylate, bromopropylate, bromuconazole, bupirimate, butocarboxim, butoxycarboxim, butralin, butroxydim, carboxin, chloroacetic acid, chlorpropham, chlorpyrifos, clodinafop, clomazone, cycloxydim, cyflufenamid, cyfluthrin, cyhalofop, cypermethrin, cyprodinil, diammonium ethylenebis(dithiocarbamate), diclofop, dicofol, difenoconazole, diflumetorim, dimepiperate, dimethachlor, dimethametryn, dimethoate, dimethylvinphos, dinobuton, diphenylamine, dithiopyr, DNOC (4,6-dinitro-o-cresol), EPN (O-ethyl O-4-nitrophenyl phenylphosphonothioate), esfenvalerate, ethalfluralin, ethiofencarb, ethofumesate, ethychlozate, etobenzanid, etofenprox, famphur, fenamiphos, fenazaquin, fenobucarb, fenothiocarb, fenoxanil, fenoxaprop, fenoxycarb, fenpropathrin, fentrazamide, fenvalerate, flamprop-M, flufenacet, flumiclorac, fluoroglycofen, flurenol, flurochloridone, fluroxypyr, flusilazole, haloxyfop-P, hymexazol, imazalil, imibenconazole, indanofan, indoxacarb, ipconazole, isoprocarb, isopropyl O-(methoxyaminothiophosphoryl)salicylate, isoprothiolane, lactofen, linuron, MCPA-thioethyl, mecoprop, mepronil, metalaxyl, metamifop, metazachlor, methamidophos, methidathion, methomyl, methoxychlor, methyldymron, methyl isothiocyanate, monocrotophos, monolinuron, myclobutanil, naled, napropamide, nitenpyram, nitrapyrin, nitrothal-isopropyl, oxadiazon, oxyflurofen, penconazole, pendimethalin, pentanochlor, permethrin, pethoxamid, 2-phenylphenol, phosalone, phosmet, picoxystrobin, pirimicarb, pluchloralin, primicar, prochloraz, prometon, propachlor, propamocarb hydrochloride, propanil, propaquizafop, propham, propoxur, proquinazid, pyraclostrobin, pyrazophos, pyributicarb, pyridaphenthion, pyridate, pyrimethanil, pyrimidifen, pyriproxyfen, quinalphos, quizalofop, resmethrin, silthiofam, simetryn, tebufenpyrad, tefluthrin, temephos, tepraloxydim, tetramethrin, thenylchlor, thiazopyr, thiofanox, tolclofos, tolfenpyrad, transfluthrin, triacontanol, triadimefon, triallate, triazamate, trichlorfon, trifloxystrobin, triflumizole, trifluralin, trinexapac, vamidothion, as well as any applicable esters or salts thereof.

In certain embodiments, the invention is particularly directed to solid formulations of herbicidally active low melting compounds. In specific embodiments, the herbicidally active compound comprises a compound according to Formula (1) below:

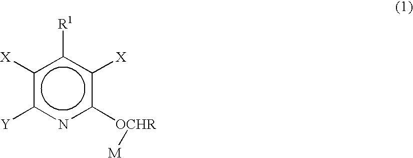

wherein X is chloro, bromo, or fluoro; Y is hydrogen, chloro, bromo, fluoro, C₁₋₄ alkyl, amino, or C₁₋₄ alkylamino; R¹ is hydrogen, C₁₋₄ alkyl, amino, or C₁₋₄ alkylamino; M is hydrogen or C₁₋₄ alkyl; R is CN, —CONR³R⁴, or COOR²; R² is C₁₋₁₂ branched or linear alkyl or alkoxy; and R³ and R⁴ independently are hydrogen or C₁₋₈ alkyl.

In one embodiment, the herbicidally active compound in the solid formulation comprises a compound according to Formula (1), wherein X is chloro, Y is fluoro, R¹ is amino, and M is hydrogen.

In another embodiment, the herbicidally active compound in the solid formulation comprises a compound according to Formula (1), wherein X is chloro, Y is fluoro, R¹ is amino, M is hydrogen, and R is COOR².

In still another embodiment, the herbicidally active compound in the solid formulation comprises a compound according to Formula (1), wherein X is chloro, Y is fluoro, R¹ is amino, M is hydrogen, R is COOR², and R² is hydrogen.

In yet another embodiment, the herbicidally active compound in the solid formulation comprises a compound according to Formula (1), wherein X is chloro, Y is fluoro, R¹ is amino, M is hydrogen, R is COOR², and R² is C₁₋₁₂ branched or linear alkyl. Preferably, R² is 1-methylheptyl.

In another embodiment, the herbicidally active compound in the solid formulation comprises a compound according to Formula (1), wherein X is chloro, Y is fluoro, R¹ is amino, M is hydrogen, R is COOR², and R² is C₁₋₁₂ branched or linear alkoxy. Preferably, R² is 2-butoxy-1-methylethyl.

Unless otherwise described herein, the term “alkyl” means saturated straight, branched, or cyclic hydrocarbon groups. In specific embodiments, alkyl refers to methyl, trifluoromethyl, ethyl, propyl, isopropyl, cyclopropyl, butyl, isobutyl, t-butyl, pentyl, cyclopentyl, isopentyl, neopentyl, hexyl, isohexyl, cyclohexyl, cyclohexylmethyl, 3-methylpentyl, 2,2-dimethybutyl, and 2,3-dimethylbutyl.

In a particularly preferred embodiment, the herbicidally active compound in the solid formulation comprises a fluroxypyr compound, particularly a fluroxypyr ester, and more particularly fluroxypyr-meptyl.

An herbicidally active compound according to Formula (1) can be prepared by any method known in the art. For example, U.S. Pat. No. 3,761,486, U.S. Pat. No. 4,542,221, U.S. Pat. No. 4,701,531, and U.S. Pat. No. 5,214,150, all of which are incorporated herein by reference, disclose various methods for preparing such herbicidally active compounds.

The amount of the low melting active compound present in the solid formulation of the invention can vary depending upon the specific active compound used, the desired strength of the final formulation, the class of low melting compound being used (i.e., herbicide, insecticide, fungicide, etc.), and the comparative loadings of the further components of the solid formulation. In one embodiment, the content of the low melting active compound ranges from about 5% by weight to about 80% by weight, based on the overall weight of the solid formulation. In further embodiments, the content of the low melting active compound can range from about 5% by weight to about 70% by weight, about 5% by weight to about 60% by weight, about 10% by weight to about 70% by weight, about 10% by weight to about 60% by weight, about 15% by weight to about 55% by weight, about 15% by weight to about 50% by weight, about 20% by weight to about 60% by weight, about 20% by weight to about 50% by weight, or about 20% by weight to about 40% by weight. In specific embodiments, the content of low melting active compound is in the range of about 20% by weight to about 30% by weight.

As further described below, the solid formulation of the invention can be prepared according to specific methods wherein the low melting active compound is initially combined with one or more specific formulation ingredients prior to blending with further ingredients used to form the final granule. The present invention is particularly useful in that one or more additional active compounds, particularly one or more further pesticidally active compounds, can be combined with the low melting active compound in the solid formulation. In particular embodiments, it is possible to prepare solid formulations comprising two, three, four, or even more pesticidally active compounds, wherein at least one of the pesticidally active compounds is a low melting active compound. Although the invention is particularly adaptable for the formulation of low melting active compounds, one or more higher melting active compounds may also be included in the formulation. According to such embodiments, there is provided a single, solid formulation comprising two or more active compounds, wherein at least one of the active compounds is a low melting active compound. The additional active compounds can be included in the formulation according to a variety of methods. For example, the additional active compound may be introduced to the formulation mixture at the same time as the low melting active. As described below, the additional active compound would thus be intimately admixed with the low melting active and a free-flow agent. In other embodiments, the additional active compound may be introduced to the formulation mixture after the low melting active is combined with the free-flow agent. Accordingly, the additional active compound would form part of the final formulation (i.e., the low melting active compound and the additional active compound would both be present in a single, final granule). Such formulations may be referred to as “combination compositions” in that a single composition comprises a combination of active compounds.

In other embodiments according to the invention, it is possible to combine the active compounds by providing blends of separate solid formulations. For example, a solid composition comprising a low melting active compound as the only active compound could be combined with another solid composition comprising a different active compound (a low melting compound and/or a higher melting active compound). In specific embodiments, the invention encompasses blends of different solid compositions. The different solid compositions can differ based on the active compounds included in the compositions (e.g., different active compounds or different concentrations of the same active compound). Such mixtures of solid compositions including pesticidally active compounds are preferably in forms that remain homogenous when stored, handled, and dispensed (i.e., the mixtures are “homogeneous blends” of the different solid compositions). Homogenous blends of solid compositions (such as in a granular form) result when mixing different granules of substantially similar size and shape. Such mixtures that remain homogenous make it possible to dispense the contents in part and provide a reproducible composition (i.e., the overall composition of the mixed granules is substantially unchanged from the first dispensing from a container to the last dispensing from the same container). Therefore, containers of the mixtures of different solid compositions according to certain embodiments of the present invention can be made up of two or more different pesticidal granules (or other solid composition form) and provide a non-segregating composition. A mixture of the different solid compositions according to the invention can be containerized in other than a unit package and be flexibly dosed in two or more uniform portions. By uniform portions it is meant that the mixture will not vary in pesticide assay beyond a range that is acceptable according to any regulatory agencies governing agricultural compositions. In one embodiment, the present invention provides a homogeneous mixture comprising two or more groups of solid pesticidal granules, wherein the granules differ in pesticide, pesticide content, or inert content. Such granules can be formed by extrusion or pelletization, as further described below. Moreover, the granules can have specific shapes and/or dimensions that differ from each other by no more than a specified range to facilitate formation of the homogeneous blend. One system for the preparation of homogeneous blends of different solid compositions is provided in U.S. Pat. No. 6,022,552, which is incorporated herein by reference in its entirety. Accordingly, in some embodiments, the invention comprises a mixture of two or more distinct formulations, each of the formulations being in a solid form, and each of the formulations comprising different pesticides, different contents of the same pesticide, or different inert materials, wherein at least one of the formulations comprises a low melting active compound.

Any herbicide amenable to solid formulation could be combined with a low melting active compound in a solid formulation according to the present invention (i.e., to form a combination composition). Non-limiting examples of the types of active compounds useful in combination with a low melting active compound according to the present invention include: acetanilides, amides, amidines, anilides, arylaminopropionic acids, arylalanines, aryloxycarboxylic acids, aryloxyplenoxy-propionates (“fops”), azoryls, benzilates, benzofurans, benzoic acids, benzoylcyclohexanediones, benzofuranyl alkylsulfonates, benzothiazoles, benzoxazoles, benzoylpyrazoles, bipyridyliums, carbamates, carbanilates, carboxamides, chloroacetamides, chloroacetanilides, chlorotriazines, cyclodienes, cyclohexanediones (“dims”), cyclohexane oximes, cyclopropylisoxazoles, dicarboximides, dinitroalilines, dinitrophenols, diphenyl ethers, dithiocarbamates, dithiolanes, glycines, halogenated aliphatics, imidazoles, imidazolinones, isoazolidinones, methoxytriazines, methylthiotriazines, neonicotinoids, nitriles, nitroanilines, nitrophenylethers, N-phenylphthalimides, organoarsenicals, organophosphates, organophosphorus, oxadiazines, oxadiazolinones, oxazoles, oxyacetamides, phenoxyalkanoic acids, phenyl carbamates, ureas, phenoxys (including substituted phenoxys), phenoxyacetics, phenoxybutyrics, phenoxycarboxylic acids, phenoxypropionics, phenylamides, phenylethylenediamines, phenylpyrazoles, phenylpyridazines, phenylureas, phosphinic acids, phosphorodithioates, phthalic acids, picolinic acids, pyrazoles, pyrethroids, pyridazines, pyridazinones, pyridines, pyridine carboxylic acids, pyrimidinamines, pyrimidinyloxybenzoic acids, pyrimidinylthiobenzoic acids, quaternary ammoniums, quinazolinones, quinoline carboxylic acids, strobilurins, sulfonamides, sulfonanilides, sulfonylaminocarbonyltriazolinones, sulfonylureas, tetrazolinones, thiadiazoles, thiadiazolylureas, thiocarbamates, thiocarbonates, thioureas, triazines, triazoles, triazolones, triazinones, triazolopyrimidines, triketones, uracils, and ureas (including substituted ureas). Of course, it is understood that active compounds from any of the above classes of compounds could also be used in separate solid formulations that could be mixed or otherwise combined with the solid formulations according to the invention comprising a low melting active compound (i.e., forming mixes of granules with different active compounds, as described above).

In other embodiments, the additional active compounds useful as described herein (e.g., in combination compositions with a low melting active compound or in mixtures of two or more different solid formulations, each differing in active compound, content of active compound, or content of inert materials) can be selected based on their activity. For example, compounds useful in combinations according to the present invention can include: ACCase inhibitors, ALS inhibitors, ESPS inhibitors, synthetic auxins, PPO inhibitors, and photosystem II inhibitors. ACCase inhibitors are typically recognized as grass-controlling compounds in light of their activity against acetyl coenzyme A carboxylase (ACCase), which is part of the first step of lipid synthesis. ALS inhibitors inhibit the acetolactate synthase (ALS) enzyme (also known as acetohydroxyacid synthase, or AHAS), which is the first step in the synthesis of the branched-chain amino acids (e.g., valine, leucine, and isoleucine). Thus, such herbicides deprive affected plants of these amino acids leading to inhibition of DNA synthesis. The ALS inhibitor family includes sulfonylureas (SUs), imidazolinones (IMIs), triazolopyrimidines (TPs), pyrimidinyl oxybenzoates (POBs), and sulfonylamino carbonyl triazolinones (SCTs). EPSPS inhibitors affect the enolpyruvylshikimate 3-phosphate synthase enzyme (EPSPS), which is used in the synthesis of the amino acids tryptophan, phenylalanine and tyrosine. Accordingly, EPSPS inhibitors affect grasses and dicots alike. Synthetic auxins mimic the auxin plant hormone and thus have several points of action on the cell membrane. Protoporphyrinogen oxidase inhibitors function by inhibiting the protoporphyrinogen oxidase (PPO) enzyme, which is in the pigment synthesis pathway. The PPO inhibition starts a reaction in the cell that ultimately causes the cell membranes to leak, and the leaking cell membranes rapidly dry and disintegrate. Photosystem II inhibitors reduce electron flow from water to NADPH²⁺ at the photochemical step in photosynthesis. They bind to the Qb site on the D1 protein and prevent quinone from binding to this site. Accordingly, this group of compounds causes electrons to accumulate on chlorophyll molecules in excess of normally tolerated amounts, which leads to plant death.

In embodiments according to the invention wherein the low melting active compound is combined with one or more further active compounds (either in the same formulation or in a mixture of two or more different, separate formulations), the one or more further active compound can be selected from a wide variety of specific active compounds. In particular embodiments, the one or more further active compounds can be any pesticidally active compounds. When the one or ore pesticidally active compounds are not combined with the low melting active compound in a single formulation, the one or more additional pesticidally active compounds can be mixed with the formulation of the low melting active compound in a variety of manners including, but not limited to, dry mixing or tank mixing.

Specific, non-limiting examples of acaricides that can be combined according to the present invention with any low melting active compound, as previously described, include the following: hexathizox, oxythioquinox, dienochlor, and cyhexatin.

A specific, non-limiting example of a bactericide that can be combined according to the present invention with any low melting active compound, as previously described, include the following: oxytetracycline dehydrate.

Specific, non-limiting examples of fungicides that can be combined according to the present invention with any low melting active compound, as previously described, include the following: carbendazim, thiuram, dodine, chloroneb, captan, famoxadone, folpet, thiophanatemethyl, thiabendazole, chlorothalonil, dichloran, captafol, iprodione, vinclozolin, kasugamycin, triadimenol, flutriafol, flusilazol, hexaconazole, and fenarimol.

Specific, non-limiting examples of herbicides that can be combined according to the present invention with any low melting active compound, as previously described, include the following: acifluorfen, aclonifen, allidochlor, ametridone, amibuzin, amicabizone, amidosulfuron, aminopyralid, amitrole, anilofos, anisuron, asulam, atrazine, azimsulfuron, azafenidin, beflubutamid, bencarbazone, bensulfuron, bensulide, bentazon, benzadox, benzipram, bifenox, bilanafos, bromacil, bromobonil, bromobutide, bromophenoxim, bromoxynil, hydroxybenzonitrile, butamifos, buturon, cafenstrole, carboxazole, chlomethoxyfen, chlorbromuron, chloramben, chlorazifop, chloreturon, chlorimuron, chlomitrofen, chlorotoluron, chloroxuron, chloroxynil, chlorprocarb, chlorpyrafos, chlorsulfuron, cinosulfuron, cliodinate, clomeprop, clorasulam, cyanazine, cyclosulfamuron, clofop, clopyralid, CDEA, cyprazole, dazomet, desmediphan, diamuron, difenoxuron, dinaoseb, dicamba, difenopenten, dichlorbenil, dichlofop, dichlorprop, diclosulam, dimefuron, dimethenamid, dinofenate, dinoprop, dinosam, dinoterb, DNOC, 2,4-DEB, 2,4-DEP, DMPA, EBEP, diphenamid, dipropetryn, dischlormate, disul, dithiopyr, diuron, epronaz, erbon, ethametsulfuron, etinofen, etnipromid, ethoxyfen, ethoxysulfuron, fenac, fenasulam, fenoxaprop, fenteracol, fenthiaprop, fentrazamide, fenuron, flazasulfuron, florasulam, fluazifop, flucarbazone, flucetosulfuron, flumetsulam, fluometuron, fluothiuron, flupoxam, fluorodifen, fluoroglycofen, fluoronitrofen flupyrsulfuron, fluridone, flupoxam, fomesafen, foramsulfuron, fosamine, furyloxyfen, glufosinate, glyphosate, halosafen, halosulfuron, haloxydine, haloxyfop, hexazinone, imazamethabenz, imazamox, imazapic, imazapyr, imazaquin, imazethapyr, imazosulfuron, iodobonil, iodosulfuron, ioxynil, isocarbamid, isomethiozin, isoproturon, isouron, isoxapyrifop, isoxaben, karbutilate, KIH-485, lactofen, lenacil, MCPA, MCPB, medinoterb mefenacet, mefluidide, mesosulfuron, metamifop, metamitron, methabenzthiauron, methazole, metosulam, metribuzin, methiuron, methyldymuron, metobenzuron, meoxuron, metsulfuron, monolinuron, monuron, naptalam, neburon, nicosulfuron, nitralin, nitrofen, nitrofluorfen norflurazon, orthosulfamuron, oryzalin, oxasulfuron, oxyfluorfen, parafluron, penoxsulam, perfluidone, pethoxamide, phenmedipham, phenobenzuron, picloram, picolinafen, pinoxaden, piperophos, primisulfuron, prometryn, pronamide, propanil, propaquizafom, propazine, propoxycarbazone, propyzamide, prosulfuron, pyraclonil pyrazon, propyrisulfuron, pyriclor, pyroxsulam, pyrazosulfuron, rimsulfiron, saflufenacil, siduron, simazine, sulfentrazone, sodium 2-chloro-6-(4,6-dimethoxy pyrimidine-2-ylthio)benzoate, sulfometuron, sulfosulfuron, tebutam, tebuthiuron, terbacil, terbuthylazine, terbucarb, terbutryn, tetrafluron, thiameturon, thiazopyr, thidiazuron, thiencarbazone, thifensulfuron, triasulfuron, tribenuron, triclopyr, 2,4-D, 2,4-DB, trifloxysulfuron, trifop, trifopsime, triflusulfuron, tritosulfuron, 2-[2,4-dichloro-5-[(2-propynyl)oxy]phenyl-5,6,7,8-tetrahydro-1,2,4-triazol o-[4,3-a]-pyridin-3-(H)-one, methyl 2-[[[[(4,6-dimethoxy-2-pyrimdinyl)amio]carbonyl]amino]sulfonyl]-6-(trifluoromethyl)-3-pyridinecarboxylate sodium salt, N-[(4,6-dimethoxypyrimidin-2-yl)aminocarbonyl]-1-methyl-4-(2-methyl-2H-tetrazol-5-yl)-1H-pyrazole-5-sulfonamide, and N-[(4,6diethoxypyrimidin-2-yl)aminocarbonyl]-1-methyl-4-ethoxycarbonyl-5-pyrazolesulfonamide.

Specific, non-limiting examples of insecticides that can be combined according to the present invention with any low melting active compound, as previously described, include the following: carbofuran, carbaryl, methyl 7-chloro-2,5-dihydro-2-[[methoxycarbonyl)4-(trifluoromethoxy)phenylamino)-carbonyl)inden-(1,2-E)(1,3,4)oxadiazine-4A-carboxylate thiodicarb, deltamethrin, and tetrachlorvinphos.

The low melting active compound may particularly be in a particulate form. As used herein in relation to the low melting active compound, a particle or a particulate form can refer to any generally particle-shaped form, including crystalline forms, solid amorphous forms, or any other form that is one or more relatively small, generally solid individual units. The individual particles may be relatively coarse, fine, or a combination thereof. As low melting active compounds may tend to be somewhat softened even at ambient conditions, the compounds are not typically amenable to grinding to highly specific particle sizes. The present invention is particularly useful in that the free-flow agent can be embedded in the surface of the low melting active compound particles, and such action is not necessarily limited by the size distribution of the low melting active particles.

In addition to the low melting active compound, the solid formulation of the invention can comprise various further components useful for facilitating formation of the solid material and/or useful for imparting various properties to the solid material for use in various methods. For example, in one embodiment, the ability to prepare a solid formulation of a low melting active compound arises from the incorporation of a free-flow agent. As previously pointed out, low melting compounds exhibit physical properties making the compound not amenable to solid formulation, which often includes forming various mixtures in various solid states. Low melting compounds typically are soft and tacky at processing temperatures causing the compound to stick to itself rather than allowing formation of a homogeneous dispersion with the additional solid formulation components. According to the present invention, however, this difficulty has been overcome, in part, through the use of a free-flow agent that is appropriately compatible with the low melting compound so that, when the two ingredients are combined, the low melting compound becomes intimately combined with the free-flow agent to form an intermediate material wherein the low melting compound is in a form allowing for further processing and combination with the remaining composition components. In specific embodiments, the low melting active compound can be so intimately combined with the free-flow agent, such as through the application of shear, that the combined material exhibits certain physical characteristics of the free-flow material in preference to the low melting active compound. In particular, the combined materials will behave like the pure-free flow agent in relation to flow and non-stick characteristics.

In the field of formulations that are powdered, granulated, or the like, a free-flow agent (also sometimes known as an anti-caking agent) is typically recognized as being a material useful to maintain the bulk powder, bulk granules, etc., in a free-flowing or non-caked state. Free-flow describes the act of maintaining the velocity of a moving powder (or granules). Accordingly, free-flow agents are preferably materials useful to prevent packing of particles, coat and smooth the edges of bulk powders (or granules) to reduce interparticle friction, and adsorb excess moisture from the atmosphere before it can be absorbed by the bulk powder (or granules).

Any material typically recognized as a free-flow agent or anti-caking agent can be used according to the present invention. Preferably, the free-flow agent is a solid material. In specific embodiments, the free-flow agent is a material having preferred flow characteristics in combination with large relative surface area. Non-limiting examples of free-flow agents include sodium ferrocyanide, ferric ammonium citrate, silicon dioxide, aluminum dioxide, aluminum calcium silicate, calcium silicate, magnesium silicate, magnesium carbonate, and sodium alumino silicate. In specific embodiments, a free-flow agent for use in the present invention comprises a solid, silica-containing compound, including, but not limited to, hydrophobic silica, synthetic precipitated silicas, and hydrated amorphous silicas. In specific embodiments, the free-flow agent can be a material known by the names FLO-GARD®, HI-SIL®, LO-VEL®, SAN-SIL®, or SILENE® (all available from PPG Industries, Pittsburgh, Pa.), as well as Toxisil 38 AB. Yet further examples of free-flow agents useful in the present invention are the SYLOID® silicas available from W.R. Grace & Co.

In particular embodiments, the free-flow agent used according to the invention comprises materials based on SiO₂, such as the HI-SIL® line of materials, particularly HI-SIL® 233, and Toxisil 38AB. Silicon dioxide based materials provide advantageous particle size distributions with high surface area for binding with the soft, tacky fluroxypyr compound. Furthermore, SiO₂ compounds often have particle shapes providing for good flow characteristics. Still further, the expanded surface area of SiO₂ based materials actually contributes to matrix cooling by allowing for a wider distribution of processing temperatures.

In some embodiments, the free-flow agent can be a particulate material wherein the particles have a defined surface area. For example, the free-flow agent particularly may have a BET-5 surface area of about 5 m²/g to about 500 m²/g, about 25 m²/g to about 400 m²/g, about 50 m²/g to about 300 m²/g, or about 75 m²/g to about 250 m²/g. The multipoint Brunauer, Emmett, and Teller (BET) surface area of a particle, such as a free-flow agent used according to the present invention, can be determined using ASTM D1933-03 (2008), the multipoint BET nitrogen adsorption test.

In other embodiments, the free-flow agent can be a particulate material wherein the particles have a defined particle size. For example, the free-flow agent particularly may have a particle size of less than about 30 microns, less than about 25 microns, less than about 20 microns, less than about 15 microns, less than about 10 microns, less than about 5 microns, or less than about 2 microns. In specific embodiments, the particles may have a size of about 0.01 microns to about 40 microns, about 0.02 microns to about 30 microns, about 0.05 microns to about 20 microns, about 0.1 microns to about 15 microns, or about 0.1 microns to about 10 microns. Particle size may be measured as the average particle size.

In specific embodiments, the formulation of the present invention is characterized by the combination of the low melting active compound and the free-flow agent. In particular, rather than merely combining the materials as discrete and separate particles, the low melting active compound used in the present inventive formulation is specifically bound to the free-flow agent. For example, in one embodiment, the low melting active compound is physically bound to the free-flow agent by mechanical means (e.g., using applied force to compress together or otherwise bind together the low melting active compound and the free-flow agent. In certain embodiments, such binding of the low melting active compound and the free-flow agent can be accomplished by way of a hammer mill or other similar apparatus capable of imparting the necessary combinatory force to physically bind the materials. In other embodiments, the low melting active compound can be melted and sprayed onto a particulate free-flow agent. Still further, the low melting active compound could be dissolved in an organic solvent prior to combination with the free-flow agent. In such embodiments, the dissolved low melting active compound could be combined with the free-flow agent and allowed to become adsorbed thereon.

Although not wishing to be bound by theory, it is believed that the ability to make formulations in the form of stable, free-flowing, non-agglomerating particles, granules, or the like arises from the combination of the low melting active compound with the free-flow agent prior to the addition of any further components of the formulation. In particular embodiments, the desired, free-flowing solid formulation can be achieved by effectively isolating individual particles of the low melting active compound and coating the individual particles with particles of the free flow agent. As described below, this requires the use of a shear force significant enough to impact the particles of the free flow agent and physically bind them to the surface of the particles of the low melting active compound or at least partially embed the particles of the free flow agent into the particles of the low melting active compound. Preferably, the low melting active compound is in a particulate form (either solid or semi-solid), and the individual particles of the low melting active compound are at least substantially completely coated with the individual particles of the free flow agent. Specifically, the particles of the low melting active compound are sufficiently coated to prevent agglomeration of the particles during further processing to form the finished solid formulation. Preferably, the particles of the low melting active compound are coated with the free flow agent such that individual particles of the free flow agent are physically attached to the exposed surface of the low melting compound particles, such as by being at least partially embedded into the exposed surface of the low melting compound particles.

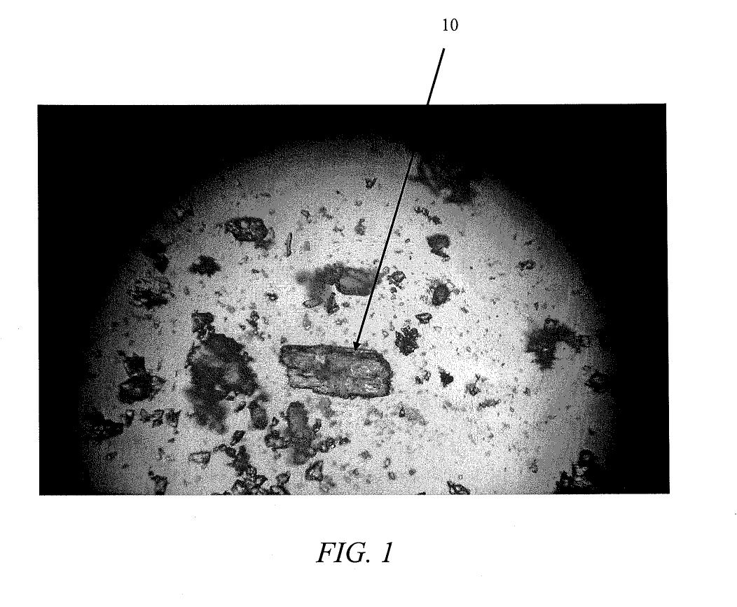

This coating mechanism is shown in FIG. 1 through FIG. 3. FIG. 1 shows a micrograph image of a fluroxypyr crystal 10. Fluroxypyr is a low melting compound useful according to the invention for preparing herbicidally active formulations. Fluroxypyr is crystalline at room temperature (as seen in FIG. 1) but tends to at least partially melt during processing.

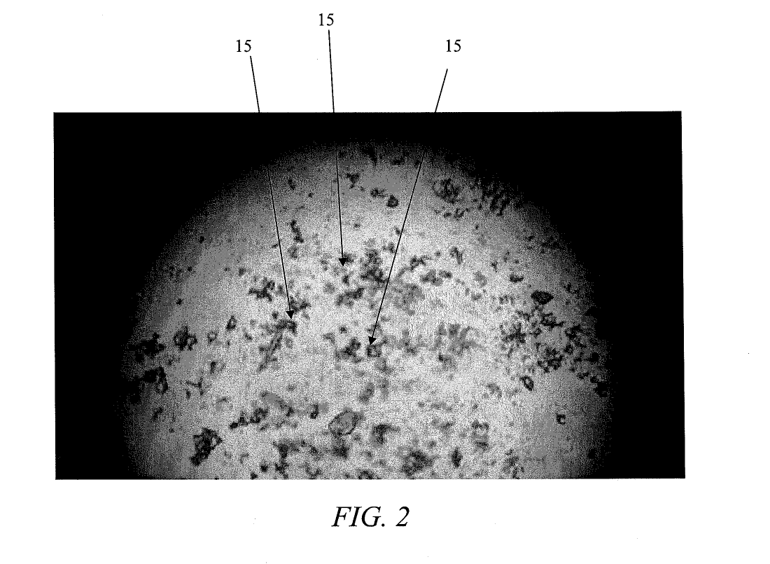

FIG. 2 shows a micrograph image of silicon dioxide particles 15. The silicon dioxide particles are isolated prior to any admixture with the fluroxypyr.

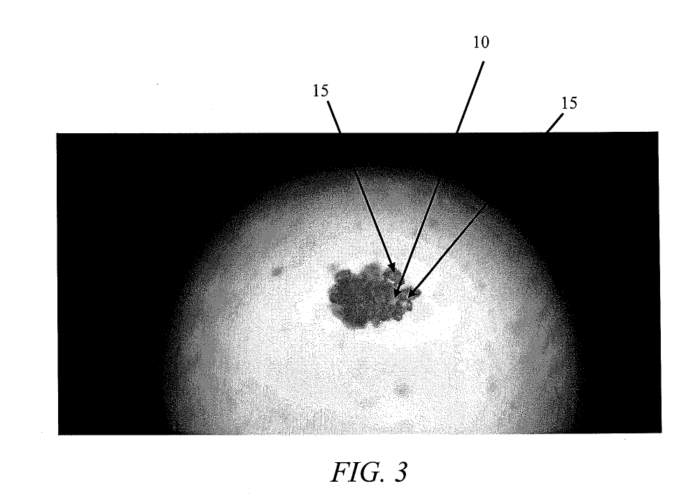

FIG. 3 shows a micrograph image of a fluroxypyr crystal 10 after the fluroxypyr and the silica have been combined with high shear mixing. As can be seen, the silicon dioxide particles 15 are surrounding the fluroxypyr crystal 10 and are physically attached to the fluroxypyr crystal 10 or embedded therein (only a small portion of the underlying fluroxypyr crystal—the lighter portion in the image—can be seen in FIG. 3 as the fluroxypyr crystal 10 is substantially completely covered by the silicon dioxide particles 15).

While not intending to be limited by theory, it is believed that the impregnation is particularly effective because of the low melting temperature of the active compound, fluroxypyr. Thus, the crystals of the low melting active compound are in a softened state during milling and readily accept impregnation by the rough, irregularly shaped particles of the free-flow agent, such as silicon dioxide. Accordingly, while the end result of a high energy mixing (e.g., milling) of a low melting active compound and a free-flow agent is illustrated in FIGS. 1-3 in relation to fluroxypyr-meptyl and silicon dioxide, it is understood that the same effect would be expected when using other low melting active compounds, either in crystalline or other particulate form.

The content of the free-flow agent used in the solid formulation can vary depending upon the type and loading of the low melting active compound. In certain embodiments, the content of the free-flow agent can be specifically related to the content of the low melting active compound, such as in a weight:weight ratio. In particular, it has been found that the ability to form a solid composition according to the invention can be strongly influenced by this ratio. For example, the weight ratio of low melting active compound to free flow agent can preferably range from about 7:1 to about 3:1. In other embodiments, the weight ratio of low melting active compound to free flow agent can range from about 6:1 to about 4:1. In one embodiment, the weight ratio of low melting active compound to free flow agent is 5:1.

In other embodiments, the content of the free-flow agent used in the solid formulation can be described based on the overall weight of the solid formulation. For example, the solid formulation can comprise from about 3% by weight to about 15% by weight, about 4% by weight to about 15% by weight, about 4% by weight to about 14% by weight, about 4% by weight to about 13% by weight, about 4% by weight to about 12% by weight, about 4% by weight to about 10% by weight, about 5% by weight to about 10% by weight, or about 6% by weight to about 10% by weight of the free-flow agent. Of course, the overall weight of free-flow agent used in the composition can vary based on the weight of the low melting active compound present.

In some embodiments, the present invention is particularly distinguishable from known solid formulation (e.g. granules) in light of the increased amount of free-flow agent used. Free flow agents, such as hydrophobic silica, are typically only used in small amounts, such as about 0.1-3% by weight, in order to achieve flow or anticakeing characteristics. In such known formulations, the silica is normally homogeneously dispersed throughout the formulation matrix, and no impregnation occurs. Since the free-flow agent is not normally tied to any other components of a formulation, it effectively provides the desired flow effects. Higher concentrations of free-flow agents have previously been avoided because at concentrations at or about 3%, the free-flow agent tended to interfere with the compaction process, which negatively affected the formation of granules. In other words, higher concentrations of the free-flow agent would prevent effective granule formation, and the granules would tend to easily disintegrate.

The solid formulations of the present invention significantly exceed the typical concentrations for free-flow agents, such as silica without negatively affecting the ability to form solid formulations, such as granules. While not wishing to be bound by theory, it is believed that a high percentage of free-flow agent can be used in the present invention because the free-flow agent is significantly tied up (i.e., impregnated) in the particles of the active compound. This effectively modifies the particles of the free-flow agent to simultaneously reduce the anti-compaction properties of the substance and protect the impregnated low melting active compound from softening and/or melting during further processing. This is a distinct departure from known uses for free-flow agents.

The solid formulations of the invention also preferably comprise one or more diluents. Any solid compound typically recognized as useful as a diluent can be used according to the invention. Diluents can be materials that extend the volume of the composition. Preferably, the diluent is formed of a material that is also useful for facilitating the solid form of the formulation. In particular embodiments the diluent is chosen based on certain physical characteristics, such as pH and particle size distribution. For example, the diluent preferably comprises a material having a pH sufficiently close to the desired formulation pH, as more fully described below, to avoid the need for excess pH adjusting component. Moreover, the diluent preferably has a particle size distribution useful to facilitate combination of the low melting active compound with the remaining composition components.

Non limiting examples of materials useful as diluents according to the invention include generally inert, natural or synthetic, organic or inorganic solid materials. Particular preference is given to those materials that are essentially insoluble in water and have large surface areas and/or high absorbencies, in particular, natural mineral powders such as kaolin, argillaceous earth, diatomaceous earth, talcum, chalk, quartz, atapulgite, montmorillonite, mica, and synthetic mineral powders such as silicic acid, alumina, silicates, in particular kaolin, resins, waxes, solid fertilizers, soluble or insoluble inorganic salts, organic derivatives, certain polysaccharide compounds (such as sugars and sugar alcohols, e.g., mannitol), urea, and specific salts, such as di-ammonium phosphate, sodium phosphate, ammonium sulfate, sodium chloride, sodium sulfate, and potassium phosphate. In specific embodiments, the diluent can be a material providing a disintegrating action that facilitates the breakup of the solid formulation in the presence of water. Examples of such materials include bentonites (natural or activated), starch and its derivatives (especially alkyl starches and carboxyalkyl starches), celluloses (especially microcrystalline cellulose) and cellulose derivatives (especially carboxyalkyl cellulose), alginates, soluble inorganic salts or crosslinked polyvinylpyrrolidone.

The content of diluent in the solid formulation can vary depending upon the overall formulation. In certain embodiments, the diluent content in the solid formulation ranges from about 10% by weight to about 90% by weight, based on the overall weight of the solid formulation. In further embodiments, the diluent content can be about 10% by weight to about 80% by weight, about 15% by weight to about 75% by weight, about 20% by weight to about 70% by weight, about 20% by weight to about 65% by weight, or about 20% by weight to about 60% by weight. In particular embodiments, the amount of diluent present in the formulation is 100% minus the sum of the weight percent of all other formulation components.

The diluent specifically is a separate component of the solid formulation and is not interchangeable with the free-flow agent described above. While the free-flow agent functions to segregate the particles of the low melting active compound, the diluent functions according to the present invention to simply extend the weight or volume of the overall formulation so that the final form of the solid formulation is of a size that is useful (e.g., a granule having a specific size). A skilled person would thus recognize that the content of the diluent can depend upon the amount of the remaining formulation components that are used for a specific formulation. Further, the diluent (or filler) material is not required to separate the particles of the low melting active compound and prevent agglomeration. Rather, as described above, the free-flow agent, by becoming embedded in the particles of the low melting active compound, performs this function separate from the diluent.

In certain embodiments, it can be useful to include one or more compounds useful for maintaining the pH of the solid formulation within a specified range. As further described below, the solid formulation of the present invention can be used in a variety of treatment methods. For example, the solid formulation may be combined with an aqueous solvent, such as to form an aqueous dispersion of the solid material. In such embodiments, it can be useful for the pH of the dispersion to maintain a specific pH range.

It may be particularly useful to maintain an acidic pH to ensure proper action of the low melting active compound. For example, the herbicide fluroxypyr is often used as an ester. After predominately foliar uptake, the ester is hydrolyzed to the parent acid, which is the herbicidally active form, and translocated rapidly to other parts of the plants where it acts by inducing auxin-type responses (e.g., leaf curling). Maintaining an acidic pH can be particularly useful to ensure formation the parent acid upon application to a plant or plant site.

In various embodiments, the solid formulation can include any material capable of providing a formulation pH that is generally acidic. Preferably, the formulation pH is about 3 to about 7, more preferably about 4 to about 7, more preferably about 5 to about 7. This can typically be accomplished through incorporation of any organic or inorganic acid recognized as useful in pesticidal formulations. Non-limiting examples of compounds useful as pH adjusters in the present invention include acetic acid, formic acid, citric acid, oxalic acid, and various mineral acids, such as hydrochloric acid, sulfuric acid, and phosphoric acid.

The amount of the pH adjuster included in the solid formulation can vary depending upon the desired effect. In certain embodiments, the amount of the pH adjuster can be based upon the desired pH of a water dispersion of the solid formulation. For example, the content of the pH adjuster can be an amount sufficient to maintain the pH of the formulation at about less than or equal to 7 when it is in a water diluted form. In other embodiments, the content is an amount sufficient to maintain a pH of about 4 to about 7 or about 5 to about 7 when in the water diluted form. In specific embodiments, the content of the pH adjuster in the solid formulation is about 0.1% by weight to about 2% by weight. In further embodiments, the content of the pH adjuster is about 0.2% by weight to about 2% by weight, about 0.2% by weight to about 1.5% by weight, or about 0.2% by weight to about 1% by weight. It may be desirable to adjust the content of the pH adjuster higher for use in known environments wherein the composition will be mixed with a carrier, such as water, known to have a particularly basic pH. For example, it is known for water in certain geographic locations to naturally have a pH as high as 8 or 9. The invention thus encompasses the inclusion of increased amounts of pH adjuster to ensure a properly acidic pH is maintained during mixing in such locations.

The solid formulation can further comprise one or more adjuvants that can be chosen from, for example, wetting agents, dispersants, binding agents, anti-foam agents, humectants, dessicants, lubricants, disintegrants, and any other components typically useful in solid pesticidal formulations.

The wetting agent may comprise one or more nonionic surfactants, cationic surfactants, anionic surfactants, amphoteric surfactants, silicone surfactants, fluorocarbon surfactants and mixtures thereof.

Examples of suitable nonionic surfactants include alkylpolyglucosides; glycerol esters such as glyceryl monolaurate, and ethyoxylated glyceryl monococoate; ethoxylated castor oil; ethoxylated reduced sugar esters such as polyoxyethylene sorbitol monolaurate; esters of other polyhydric alcohols such as sorbitan monolaurate and sucrose monostearate; ethoxylated amides such as polyoxyethylene cocoamide; ethoxylated esters such as monolaurate of polyethylene glycol 1000 and dilaurate of polyethylene glycol 6000; ethoxylated alkyl or arylphenols such as nonylphenol alkoxylate, octylphenol ethoxylates, dodecylphenol ethoxylates, dinonylphenol ethoxylates and tristyrylphenol ethoxylates; alcohol ethoxylates such as fatty alcohol ethoxylates (e.g., oleyl alcohol ethoxylate), tridecylalcohol ethoxylates and other alcohol ethoxylates such as NEODOL® and oxoalcohol ethoxylates; and ethylene oxide/propylene oxide copolymers such as PLURONIC® type, TETRONIC® type, or TERGITOL XH® type.

Examples of suitable cationic surfactants include alkylamine ethoxylates (including etheramines and diamines) such as tallowamine alkoxylate, cocoamine alkoxylate, etheramine alkoxylate, tallow ethylenediamine alkoxylate and amidoamine ethoxylates; alkylamine quaternary amines such as alkoxylated quaternary amines (e.g., ethoxylated quaternary amines or propoxylated quaternary amines); alkylamine acetates such as tallowamine acetate or octylamine acetate; and amine oxides such as ethoxylated amine oxides (e.g., N,N-bis(2-hydroxyethyl)cocoamine Boxide), nonethoxylated amine oxides (e.g., cethyldimethylamine Boxide) and amidoamine oxides.

Examples of suitable anionic surfactants include fatty soaps such as ammonium tallowate and sodium stearate; alkyl sulfates such as sodium C₈₋₁₀ alcohol sulfate, sodium oleyl sulfate, and sodium lauryl sulfate; sulfated oils such as sulfated castor oil; ether sulfates such as sodium lauryl ether sulfate, ammonium lauryl ether sulfate, and ammonium nonylphenol ether sulfate; sulfonates such as petroleum sulfonates, alkylbenzene sulfonates (e.g., sodium (linear) dodecylbenzene sulfonate or sodium (branched) dodecylbenzene sulfonate), alkylnapthalene sulfonates (e.g., sodium dibutylnapthalene sulfonate), alkyl sulfonates (e.g., alpha olefin sulfonates), sulfosuccinates such as dialkylsulfosuccinates (e.g., sodium dioctylsulfosuccinate) and monoalkylsulfosuccinate and succinamides (e.g., disodium laurylsulfosuccinate and disodium N-alkylsulfosuccinamate); sulfonated amides such as sodium N-methyl N-coco taurate; isethionates such as sodium cocoyl isethionate; sarcosinates such as N-lauroyl sarcosine; and phosphates such as alkylether alkoxylate phosphates and alkylarylether ethoxylated phosphates.

Examples of suitable amphoteric surfactants include betaines such as simple betaines (e.g., cocodimethylbetaine), sulfobetaines, amidobetaines, and cocoamidosulfobetaines; imidazolinium compounds such as disodium lauroamphodiacetate, sodium cocoamphoacetate, sodium cocoamphopropionate, disodium cocoaminodipropionate, and sodium cocoamphohydoxypropyl sulfonate; and other amphoteric surfactants such as N-alkyl, N,-bis(2-hydroxyethyl)glycine and alkylaminedipropionates.

Examples of suitable silicone surfactants include ethoxylated or propoxylated silicone based surfactants, e.g., SILLOUETTE® L-77 or BREAK-THRU® S-200. Examples of suitable fluorocarbon surfactants include anionic fluorinated surfactants, e.g. DUPONT ZONYL® FSK, amphoteric fluorinated surfactants, e.g., DUPONT ZONYL® TLF-9579, and nonionic fluorinated surfactants, e.g. DUPONT ZONYL® FSH.

In particular embodiments, the wetting agent comprises a salt of the alkylarylsulfonate type, especially alkali metal alkylbenzenesulfonates or alkylnaphthalenesulfonates, or a salt of the alkylsulfonate type. Specific examples of wetting agents useful according to the invention include linear alkylbenzene sulfonates, such as STEPWET® DF90.

In relation to the foregoing wetting agents and surfactants, the term “alkyl” preferably means, unless otherwise specified, linear or branched, saturated or unsaturated hydrocarbyl chains having about 8 to about 22 carbon atoms.

Other materials, including water and/or glycols, can optionally be admixed with the adjuvant or adjuvants prior to addition to the mixture. The surfactants and wetting agents generally useful in the solid formulations of the invention are disclosed in publications such as: “McCutheon's Detergents and Emulsifiers Annual”, MC Publishing Corp., Ridgewood, N.J., USA 1981; H. Stache, “Tensid-Taschenbuch”, 2nd ed., C. Hanser, Munich, Vienna, 1981; and M. and J. Ash, “Encyclopedia of Surfactants”, Vol. I-III, Chemical Publishing Co., New York, N.Y., USA 1980-1981, all of which are incorporated herein by reference.

Wetting agents can be incorporated into the solid formulation of the invention in concentrations of up to about 5% by weight, based on the overall weight of the formulation. In specific embodiments, the solid formulation comprises about 0.1% by weight to about 5% by weight or one or more surfactants. In further embodiments, the formulation comprises a surfactant in a concentration of about 0.2% by weight to about 4% by weight, about 0.2% by weight to about 3% by weight, or about 0.5% by weight to about 2% by weight. Preferably, the amount of wetting agent used in the inventive composition is maintained below about 5% to achieve maximum wetting performance while avoiding formation of excessive foam and lowering the of the suspension properties when the solid composition is mixed in a carrier, such as water.

Examples of compounds that may be used as dispersing agents, or dispersants, include polymers of arylsulfonate type, especially the alkali metal polynaphthalenesulfonates obtained by condensation of (alkyl)arylsulfonates with formaldehyde, lignosulfonates, polyphenylsulfonates, salts of polyacrylic acids, salts of lignosulfonic acids, salts of phenolsulfonic or naphthalenesulfonic acids, taurine derivatives (especially alkyltaurates), phosphoric esters of polyoxyethylenated phenols or alcohols, esters of fatty acids and of polyols, or the derivatives of the above compounds containing sulfate, sulfonate and phosphate functional groups. Dispersants may also be recognized as so-called water-soluble soaps, as well as water-soluble synthetic surface-active compounds. Soaps usually are alkali, earth alkali or optionally substituted ammonium salts of higher fatty acids (C₁₀₋₂₀), e.g., the sodium or potassium salts of oleic or stearic acid or of mixtures of natural fatty acids which are prepared, for example, from coconut or tallow oil. Furthermore, methyl-taurine salts of fatty acids may be used. In specific embodiments, the dispersant can comprise fatty sulfonates, fatty sulfates or alkyl aryl sulfonates, which can specifically be alkali, earth alkali or optionally substituted ammonium salts and have an alkyl moiety of 8 to 22 carbon atoms, whereby alkyl also means the alkyl moiety of acyl residues, such as the sodium or calcium salt of lignin sulfonic acid, of sulfuric acid dodecylate, or of a mixture of fatty alcohols prepared from natural fatty acids, in particular, sodium lignin sulfonate. This also includes the salts of sulfuric acid esters, sulfonic acids and adducts of fatty alcohols and ethylene oxide. Alkyl aryl sulfonates are, for example, the sodium, calcium or triethyl ammonium salts of dodecyl benzene sulfonic acid, dibutyl naphthalene sulfonic acid or of a condensate of naphthalene sulfonic acid and formaldehyde. Furthermore, phosphates, such as the salts of the phosphoric acid ester of a p-nonylphenol-(4-14)-ethylene oxide adduct or phospholipids, may be used. In addition, non-ionic dispersants may be used. Preferred are block polymers obtainable from propylene oxide and ethylene oxide, in particular, block polymers which consist of a polyoxypropylene core having a molecular weight of about 3,000 to about 3,500 and the remainder having a combined molecular weight of about 6,000 to 7,000 comprising ethylene oxide units. In particular embodiments, dispersants useful according to the invention include anionic lignosulfonates, such as STEPSPERSE® DF500 and STEPSPERSE® DF200.

The solid formulation according to the present invention can comprise about 2% by weight to about 25% by weight of one or more dispersants. In specific embodiments, the dispersant content is about 5% by weight to about 20% by weight, about 5% by weight to about 18% by weight, about 7% by weight to about 15% by weight, or about 8% by weight to about 12% by weight, based on the overall weight of the formulation.

The solid formulation of the invention can particularly further comprise one or more compounds having a binding action, that is to say a compound of polymeric type which is helpful to the cohesion and use of the solid formulation. Such binders can be present in preferred embodiments but are not necessarily required in all embodiments of the invention. According to preferred embodiments, it has been found that a minimum concentration of binder can be useful to ensure the formed solid particles (e.g., granules) have sufficient cohesion to maintain the low melting active compound therein. The binder is preferably a material that will adhere to all formulation ingredients (e.g., the low melting active compound, the free-flow agent, and the diluent) and will, upon compaction, create a particle with sufficient integrity so that it will not easily break apart. The specific amount of binder added can thus depend upon the total of the other ingredients of the composition. Thus, determination of a suitable binder and the correct amount of binder to be used is not a simple matter but one that requires detailed analysis of the overall composition and the desired end result. If a sufficient amount of binder is not provided, the solid composition particles can be tacky and will not exhibit the free-flowing characteristic desired in solid composition form. Conversely, if too much binder is added, the final composition will not have a suitable dispersion rate when introduced into an aqueous tank (e.g., for mixing in the field with other materials to be applied) thus creating a particle that will take to long to disperse.

Non-limiting examples of compounds useful as a binder according to the present invention include gums, especially gum arabic; adhesives, especially dextrin (and particularly maltodextrins); sugars, especially glucose and lactose; cellulose derivatives, especially alkyl cellulose and carboxyalkyl cellulose; starch; flour; polymers, especially polyvinylpyrrolidone, poly(vinyl alcohol), polyethylene glycol, polyacrylate or poly(vinyl acetate); soluble waxes; and alkali metal silicates.

The solid formulation according to the present invention preferably comprises at least about 1% by weight of one or more binders and more preferably at least about 2%, at least about 3%, or at least about 4% by weight of one or more binders. In certain embodiments, the solid formulation can comprise about 1% by weight to about 15% by weight, about 3% by weight to about 15% by weight, about 4% by weight to about 12% by weight, or about 4% by weight to about 10% by weight, based on the overall weight of the formulation.

The solid formulation can also comprise one or more disintegrants. Conventionally used disintegrants can be solid compounds which are highly soluble in water, in particular, sugars, starches cross-linked celluloses, and salts such as potassium sulfate, ammonium sulfate, potassium carbonate, sodium hydrogen carbonate, and sodium acetate trihydrate.

In certain embodiments, it may be useful for the formulation to include binders and disintegrants. The binding agent and the disintegrant do not have conflicting effects in so far as the action of the binding agent is exerted in the solid state to bind together the various solid particles of the compositions according to the invention and as the action of the agent possessing disintegrating properties is exerted in the liquid state when the compositions according to the invention are dispersed in water.

Examples of suitable anti-foaming agents that may be used according to the invention include silicones (such as polydimethylsiloxanes) and fatty acids (e.g., stearic acid) or esters thereof (e.g., calcium or magnesium stearate). Such components are preferably present in a content up to about 3% by weight based on the overall weight of the formulation. In specific embodiments, the solid formulation comprises about 0.01% by weight to about 3% by weight of one or more anti-foam agents. In further embodiments, the formulation comprises an anti-foam agent in a content of about 0.02% by weight to about 2.5% by weight, about 0.05% by weight to about 2.5% by weight, or about 0.1% by weight to about 2% by weight. Specific, non-limiting examples of anti-foaming agents useful according to the invention include SAG® 1572, AF 30 IND, and magnesium stearate.

The method of preparing the inventive solid formulation can particularly be affected by the choice of anti-foaming agent (i.e., defoamer versus foam suppressant). For example, polydimethylsiloxane defoamers typically function to break foams that may form and are normally emulsion blends and will not tolerate excessive forces such as shear mixing or blending, milling, or high centrifugal force. Accordingly, when such defoamers are used, they should be added to the composition after any high shear steps have been performed (such as just prior to granulating and during the later part of any kneading process). Since the defoamer is added after most mixing has been completed, it is particularly important for the defoamer to be homogenously mixed prior to addition. Other types of anti-foaming agents, such as magnesium stearate, can rather function to suppress the formation of foams and have an additive effect with defoamers. It should be noted, however, that excessive amounts of foam suppressants should be avoided (e.g. less than about 1% by weight, preferably less than about 0.5% by weight, more preferably less than about 0.3% by weight).

In another aspect, the present invention also provides methods of preparing the solid formulations described herein. The inventive methods are particularly designed to accommodate the low melting active compounds described herein. For example, fluroxypyr-meptyl has a melting point in the range of 58° C. to 60° C. Thus, when preparing a solid formulation comprising fluroxypyr-meptyl, it is particularly useful for the processing steps to be carried out in a fashion that avoids achieving temperatures near this range. This is necessary to avoid any melting of the active compound that could result in fusion of the particles, which would have the deleterious effect of altering particle size distribution or causing agglomeration of the formulation matrix.

The method according to this aspect of the invention comprises preparing a solid formulation comprising a low melting active compound as described herein. In a specific embodiment, the method is useful for preparing a solid formulation comprising low melting pesticides, particularly low melting herbicides, such as fluroxypyr acid or ester. The method is particularly beneficial in that it allows for formation a solid material using active compounds would otherwise be restricted to liquid formulations because of the low melting point of the active compound.

In one embodiment, the method of the invention comprises the following steps: a) binding the low melting active compound to a free-flow agent, such as through high shear or other high energy mixing; b) combining the bound low melting active compound with a diluent and one or more optional formulation adjuvants to form a homogeneous mixture; and c) milling the homogeneous mixture to form particles; and d) further processing the particles to be in a solid delivery form. The milled, particulate mixture may be formed into an extrudable mix, such as by kneading the particles in the presence of a moisture-providing agent (e.g., water or other suitable liquid). The binding step particularly can comprise mixing the low melting active compound in particulate form with a free-flow agent in particulate form under high shear or impact to impregnate particles of the low melting active compound with the particles of the free-flow agent to form bound particles of the low melting active compound and the free-flow agent.

As previously pointed out, binding of the low melting active compound to the free-flow material is useful for stabilizing the active compound and ensuring the ability of the active compound to be useful in a solid form. This binding step can comprise a physical binding of the components or a chemical binding of the components. In a specific embodiment, the binding comprises blending the active compound and the free-flow agent and feeding the blended material through a mill apparatus. The blending step is useful to form a homogeneous mixture of the components.

The actual binding of the components occurs in the mill apparatus, wherein the physical conditions are controlled such that the components become physically adhered to one another. The term “bound” or the phrase “binding together” takes on a particular meaning in the present invention in that it is more than a mere mixing of the components. Rather, the components are physically joined such they are intimately admixed and do not readily separate after the binding step. For example, the particles of the free flow agent can be substantially embedded into the exposed surface of the individual particles of the low melting active compound. Preferably, as described above, the free-flow agent is a material having physical characteristics imparting good particle size distribution and large surface area. This allows for a maximum coating of the individual particles of the low melting active compound by the particles of the free-flow agent while simultaneously minimizing the overall weight percent of free-flow agent needed to achieve the necessary physical state that maintains the low melting active compound in the solid formulation throughout the remaining processing steps. This is particularly beneficial in that large quantities of diluents or fillers are not required to separately tie up the low melting active and segregate the individual particles of the low melting active. The intimate admixture of the low melting active compound and the free-flow agent according to the present invention is described above in reference to FIGS. 1-3.

In one embodiment, the binding of the low melting active compound and the free-flow agent is achieved by passing the mixed materials into a high shear or high impact apparatus, such as a high shear blender or a mechanical mill (e.g., a hammer mill). Of course, other similar apparatuses capable of imparting a similar action could also be used and are encompassed by the invention. For example, any means of mixing that imparts high shear or high impact so that the individual particles of the free flow agent are physically forced onto or at least partially into the exposed surface of the individual particles of the low melting active compound may be used. The applied shear or other force used in the mixing should be sufficient to physically attach the individual particles of the free flow agent onto or at least partially into the exposed surface of the individual particles of the low melting active compound. In specific embodiments, individual particles of the low melting active compound are impregnated with particles of the free flow agent. For such embodiments, it is preferable for the low melting active compound to be in a particulate form during the high shear or high impact mixing or blending with the free flow agent. Other methods of physically binding the free-flow agent to the low melting active compound are also encompassed by the invention.

This initial step of binding the free-flow agent to the low melting active is highly beneficial because it effective transforms the low melting active compound into free flowing particles that are highly combinable with a variety of further formulation components and capable of withstanding further processing steps, even vigorous processing steps that would normally be expected to cause melting and/or agglomeration of the low melting active compound. Further, the free-flow agent can be provided in a relatively small content relative to the content of the low melting active compound and can be added in a single addition step. In other words, there is no need to add a portion of the free-flow agent to the low melting compound in a first step and then add a further portion of the free-flow agent in a second step to effect segregation of the low melting active compound. Rather, a relatively small amount of the free-flow agent, according to the present invention, is sufficient to segregate the low melting compound yet allow for formation of a solid formulation that is stable, easily delivered for end use, and effective in a variety of modes of application, including water dispersion. Since the particles of the free-flow agent physically coat the surface of the low melting active compound particles, the coated particles are protected from agglomeration during subsequent milling steps.

After binding of the low melting active compound and the free-flow agent, this material is combined with a diluent and one or more formulation adjuvants to form a homogeneous mixture. The adjuvants can be any of the materials generally described herein. In certain embodiments, the bound active compound and free-flow agent are beneficially combined with one or more of a dispersant, a wetting agent, a binding agent, and a pH adjuster.

The step of combining the bound active compound and free-flow agent with the diluent and the one or more adjuvants can be carried out using a variety of methods. Generally, any apparatus capable of homogenously mixing a variety of solid and liquid component can be used. In one embodiment, the combining comprises blending with a ribbon blender. Such blending can be carried out for a time sufficient to form a homogeneous blend of the various components. In one embodiment, blending is carried out for a time of at least about 15 minutes, at least about 20 minutes, at least about 25 minutes, or at least about 30 minutes.

It is highly advantageous that practically all of the remaining formulation components can be added in this second process step. Since the low melting active agent is protected by the bound particles of the free-flow agent, the bound particles are easily combinable with any of the remaining formulations ingredients. This mass combination of the formulation components allows for formation of an end product with excellent dispersibility and wettability and avoids any undesirable sedimentation when forming a water dispersion of the solid formulation.

In specific embodiments, the blending is carried in a manner useful to increase the functionality of the additional components, particularly the wetting agents and dispersants, by effectively applying such components onto substantially all of the individual particles achieved in the previous mixing of the low melting active compound and the free-flow agent. For example, blending may be via a mechanical mill, such as a hammer mill.

The blended, homogeneous mixture safely can be subjected to milling (e.g., using an air mill or jet mill) to form particles. One example of a machine useful for such step is an air milling apparatus. Milling can be carried out using any means capable of sufficiently reducing particle size to the desired specifications. Such particle size reduction is necessary to achieve an end product having the necessary dispersion and suspension characteristics. Preferably, milling is carried out in a manner such that the resultant particles have an average size of less than or equal to about 20 microns. In certain embodiments, the particles formed according to the inventive method have an average size of less than about 20 microns, less than about 18 microns, less than about 16 microns, less than about 14 microns, less than about 12 microns, less than about 10 microns, less than about 8 microns, or less than about 6 microns. In further embodiments, the particles formed according to the inventive method have an average size of about 0.5 microns to about 20 microns, about 1 micron to about 15 microns, about 1 micron to about 10 microns, about 1 micron to about 8 microns, about 1 microns to about 6 microns, or about 1 microns to about 3 microns. In specific embodiments, the particles have a size distribution range such that 90% of the particles have an average size of less than 20 microns and at least 50% of the particles have an average size of about 3 microns to about 5 microns.

Again, the initial step of binding the particles of the free-flow agent to the particles of the low melting active compound actually protects the low melting active compound during this milling step. While others have attempted to form solid formulations of low melting active compounds, they have not been successful at achieving a method whereby standard blending and milling processes can be used while still avoiding undesirable melting and agglomeration of the low melting active compound. Even when a low melting active compound is segregated using a dual addition of a high content of a filler material, the segregated composition cannot be subjected to a high energy milling process because the low melting active compound is not sufficiently protected. The present invention overcomes this limitation. According to the present invention, the particles of the free-flow agent (even at a relatively low weight percent) impregnate the surface of the low melting compound particles and form a protective layer that effectively transforms the low melting compound into free flowing particles that can be subjected to high energy processing, such as air milling, without fear of agglomeration or other undesirable effects arising from the low melting temperature of the active compound. For example, cryomilling processes can be avoided.

The milled particles can be used in any known method for preparing solid formulation forms. For example, any method of forming granules could be used according to the invention. Specifically, the particles can be used in a kneading step to form a shapable mix. This can include the addition of an amount of a moisture-providing agent, such as water. The moisture-providing agent is preferably added in an amount such that the formed shapable mix has a moisture content of about 10% to about 20%. In other embodiments, the moisture content is about 12% to about 18% or about 14% to about 16%.

The kneading step also can provide an opportunity for the addition of further formulation adjuvants, particularly any additives that are preferably not subjected to high shear mixing. For example, in one embodiment, an anti-foam agent is added. As previously pointed out, certain types of anti-foam agents can be sensitive to high shear environments, and the kneading step is preferably carried out in a manner that achieves mixing of the composition without introduction of high shear forces. The adjuvants can particularly be mixed with the moisture-providing agent prior to addition of the milled particles.

Kneading is preferably carried out for a time and in a manner useful to form a shapable mix having a specific consistency. A “shapable” mix refers to a mixture have a specific consistency amendable to forming shaped, solid particles. For example, a shapable mix can comprise an extrudable mix (i.e., a mix amenable to forming extruded granules). A shapable mix could also refer to a form useful for making other types of solid particles. In the formation of extruded granules, it is useful for the shapable mix to have a dough-like consistency. Accordingly, the shaping step particularly can comprise the formation of granules, particularly extruded granules.

Although the method of the invention may be particularly described in relation to formation of granules, the invention encompasses a variety of solid forms. For example, the solid formulation of the invention can be in the form of extruded granules, pan granulated particles, wettable dry granules, pills, prills, pellets, powders, and any other similar solid form used in making pesticidal compositions.

In specific embodiments, the method can further comprise drying the formed solid formulation. Drying can be a particularly useful step to ensure the solid formulation is of a sufficiently low moisture content to maintain formulation stability. In certain embodiments, the formed solid formulation is dried to have an average moisture content of less than about 5% by weight, less than about 3% by weight, or preferably about 1% to about 2% by weight.

It is preferable for the solid formulation of the invention to be formed such that the solid is in the form of particles having a specified average size. In certain embodiments, the particles forming the final solid formulation have an average size of about 0.1 mm to about 10 mm, about 0.5 mm to about 8 mm, or about 1 mm to about 5 mm. In specific embodiments, such as granular compositions, the formed solids may take on a somewhat cylindrical shape. Accordingly, the granule size may be described in terms of granule diameter and granule length. Moreover, granule length may be described in terms of a relation to the granule diameter.

Granule diameter of granules prepared according to the present invention can be any diameter recognized as suitable in the art. In particular embodiments, granules according to the invention have an average diameter of about 0.4 mm to about 10 mm, about 0.5 mm to about 8 mm, about 0.6 mm to about 6 mm, about 0.8 mm to about 4 mm, or about 0.8 mm to about 2 mm. The length of the inventive granules, according to certain embodiments, is in the range of about 1 to 8 times the diameter of the granule. In other embodiments, the length of the granules is 1 to 6 times or 1 to 4 times the diameter of the granule.

As noted previously, in specific embodiments, it may be desirable to form homogeneous blends of different solid compositions (e.g., two or more different pesticidal granules). Since granule diameter can affect blend homogeneity, in certain embodiments, it is preferable for each of the different compositions to have average diameters that are substantially the same. In specific embodiments, the average diameter of the largest granules in the homogeneous blend is no more than about 30% larger than the average diameter of the smallest granule in the homogeneous blend. In other embodiments, the average diameter of the largest diameter granules is no more than about 20%, no more than about 15%, or no more than about 10% larger than the average diameter of the smallest diameter granules in the mixture. Preferably the average diameters of all granules in a homogeneous blend according to the invention differ by less than 10%, less than 5%, or less than 1%.

A solid formulation according to the invention can be provided in a container, such as bottles, bags, and the like. However, even though not required, the solid compositions of this invention could also be packaged in unit doses. By unit dose is meant an amount of the composition to be added to a water spray tank. The packaging for unit doses could thus be a form useful to direct admixture, such as a water soluble polymer. Similar types of packaging systems are known in the field and include pillows, bags, sacks, and other water soluble packaging. Exemplary water soluble polymers include polyethylene oxide, methylcellulose, and polyvinyl alcohol. In other embodiments, the solid formulation of the invention can be provided in the form of a table or other similar unit dose, in particular, effervescent tablets. Effervescent tablets can include a unit dose of the solid formulation of the invention in combination with effervescing materials that, upon contact with a carrier, such as water, will effervesce and facilitate release of the inventive solid composition from the tablet form. Non-limiting examples of effervescing agents that could be used according to the invention include an organic acid (such as citric, stearic, maleic, succinic, or tartaric acid) in combination with a base (such as sodium carbonate or bicarbonate).

The solid composition of the invention is particularly suited for application methods wherein an amount of the composition is tank mixed with a suitable carrier to form a fine dispersion of primary particles that can be applied to a locus by spraying. Of course, the solid composition of the invention can also be applied in its dry form. When tank mixed, the solid composition of the invention can be dispersed in a number of carriers including, without limitation, water, vegetable oils, and water-based compositions, such as liquid fertilizers. Of course, any additive commonly used in tank mixes, such as surfactants, safeners, fertilizers, antioxidants, pH adjusters, and the like could also be used with the inventive composition.

The present invention also provides methods of controlling unwanted pests. The methods may comprise applying to a locus a solid pesticidal formulation comprising a low melting pesticidally active compound, as described herein.

In specific embodiments, the methods of the invention may be directed to methods of controlling weeds. In such embodiments, the low melting active compound particularly may be a herbicide, such as fluroxypyr.

### EXAMPLES

The present invention will now be described with specific reference to various examples. The following examples are not intended to be limiting of the invention and are rather provided as exemplary embodiments.

### Example 1

### Preparation of Fluroxypyr WDG Formulations

To prepare a 25% WDG fluroxypyr formulation, 258 pounds of fluroxypyr meptyl technical and 50 pounds of HI-SIL® 233 were charged onto a ribbon blender with electronic load cells. Agitation was initiated and the compounds were blended for 20 minutes. The material was then fed through a hammer mill to bind the HI-SIL® to the fluroxypyr meptyl.

The material was transferred to a secondary ribbon blender and 90 pounds of STEPSPERSE® DF 500, 20 pounds of STEPSPERSE® DF 200, 10 pounds of STEPWET® DF 90, 508 pounds of PARAGON® clay, 40 pounds of MALTRIN® M-100, and 4 pounds of citric acid were charged into the blender. Agitation was initiated and formulation constituents were blended for a minimum of 30 minutes.

After acquiring a homogeneous mix, the batch was transferred to a vibratory feed hopper to supply the material to an air milling apparatus at a constant rate, which is useful for improved milling efficiency. Any oversized material was returned from the mill to the vibratory feeder in order to pass through the mill again. This process was continued until the dry material was milled to within specifications, whereby 90% of the particles were of average size less than 20 microns and mean particle size was less than 5 microns.

The milled product was transferred to a secondary mixer and mixed for an additional 20 minutes. The dry milled powder was fed to a kneader, and 10 pounds of SAG® 1572 defoamer was metered into the system mixed with water to provide a consistent “dough-like” material that contained approximately 15% moisture.

A low-pressure basket extruder was equipped with a 1.0 mm dye, and the “dough-like” material was fed gravimetrically into the extruder at a rate consistent with the auger speed to insure the pressure threshold of the dye was not exceeded. The extruded material was allowed to break and free fall directly into a fluid bed dryer.

The extrudates were discharged directly into a fluid bed dryer where the moisture content was reduced to between 0.5% -2.0% (preferably about 1%). The extrudates were flowed into a screening apparatus equipped with an 8 and 40 mesh US Sieve to separate oversized, good material, and fines. The prepared formulation was formed to have a composition as provided in Table 1.

TABLE 1

| Component | Weight % |
|---|---|
| Fluroxypyr Meptyl (97.5%) | 25.80 |
| STEPSPERSE ® DF 500 | 9.00 |
| STEPSPERSE ® DF 200 | 2.00 |
| STEPWET ® DF 90 | 1.00 |
| PARAGON ® Clay | 51.70 |
| MALTRIN ® M-100 | 4.00 |
| HI-SIL ® 233 | 5.00 |
| Magnesium stearate | 0.10 |
| SAG ® 1572 | 1.00 |
| Citric Acid | 0.40 |
| Total | 100% |

Another fluroxypyr WDG formulation was prepared to have an active content of about 40%. The 40% WDG formulation was prepared substantially as described above, wherein the fluroxypyr meptyl technical was first blended with the free flow agent, Toxisil 38AB, to impregnate the fluroxypyr meptyl crystals with the particles of the Toxisil 38AB.

The bound fluroxypyr meptyl was then combined with dispersants (STEPSPERSE® DF 500 and STEPSPERSE® DF 200), a wetting agent (STEPWET® DF 90), a diluent (PARAGON® clay), a binder (MALTRIN® M-100), and a pH adjuster (citric acid). This combination was then blended to a uniform consistency.

The homogeneous mixture was then milled to the desired specifications and then prepared for granulization. The dry milled powder was mixed with anti-foam agents (AF 30 IND and magnesium stearate) and water to provide a consistent “dough-like” material, which was fed gravimetrically into the extruder. The extruded material was allowed to break and free fall directly into a fluid bed dryer. The prepared formulation was formed to have a composition as provided in Table 2.

TABLE 2

| Component | Weight % |
|---|---|
| Fluroxypyr Meptyl (98.0%) | 40.9 |
| STEPSPERSE ® DF 500 | 9.0 |
| STEPSPERSE ® DF 200 | 2.0 |
| STEPWET ® DF 90 | 1.0 |
| PARAGON ® Clay | 29.6 |
| MALTRIN ® M-100 | 7.0 |
| Toxsil 38AB | 8.0 |
| Magnesium stearate | 0.1 |
| AF 30 IND | 1.0 |
| Citric Acid | 0.4 |
| Water | 1.0 |
| Total | 100% |

### Example 2

### Stability Under Accelerated Storage Conditions

The stability of a 40% WDG fluroxypyr formulation, such as described in Example 1, was evaluated. Aging stability and suspensability are key elements of a usable solid formulation. To evaluate these characteristics of the prepared granules, samples of the granules were stored for 4 weeks at a temperature of 54° C. (which is the equivalent of storage at standard room temperature—i.e., about 25° C.—for a time of 4 years) and for 8 weeks at a temperature of 40° C. (which is the equivalent of storage at standard room temperature for a time of 2 years). As illustrated below in Table 3 and Table 4, the granules exhibited almost no loss of active content after storage. The granules exhibited a slight increase in dispersion and had only a small decrease in suspensibility.

TABLE 3

| Time | Active % | Dispersion | Suspensibility |
|---|---|---|---|
| 0-time | 40.0% | 18 | 92.1% |
| 2 weeks | 39.9% | 22 | 93.8% |
| 4 weeks | 39.7% | 20 | 90.3% |

TABLE 4

| Time | Active % | Dispersion | Suspensibility |
|---|---|---|---|
| 0-time | 40.0% | 20 | 95.1% |
| 8 weeks | 39.8% | 22 | 92.7% |

The percentage of active compound present was determined using a solution of the formulation and separating by reverse phase liquid chromatography using a Luna C-18 (2) column (15 cm×4.6 mm, i.d). Other equivalent columns could also be used. A mobile phase consisting of 70% Acetonitrile, 30% HPLC Water, and 0.05% Phosphoric Acid was used. The eluted compounds were detected and quantitated with a 230 nm UV detector and digital integrator. The chromatograph detector was set to 230 nm fixed wavelength with a sensitivity of 0.02 absorbance. A flow rate of 2.0 ml/min was used with a column temperature of 40° C.

An analytical standard of know purity (P) (0.04, 0.06, and 0.08+/−0.01 g) was weighed into a 100 ml volumetric flask. Likewise, 0.06+/−0.01 g of fluroxypyr technical was weighed into a 100 ml volumetric flask. The volume was diluted with acidic acetonitrile (2.0 grams of phosphoric acid in 4 liters of acetonitrile). The mixture is ultrasonicated for 10 minutes, cooled to ambient temperature, and mixed thoroughly.

After the column has equilibrated and a stable baseline is obtained, 10 ul of the standard solutions is injected into the column. The standard solution is re-injected, and the peak area for Fluroxypyr (S) is recorded. Once calibration is complete (the areas agree within +/−1% of the average), the samples of fluroxypyr are injected, and the area (A) is recorded. The amount of fluroxypyr present in the sample is determined using the following calculations:

Standard RF=(S/weight of standard (mg)) (1)

Sample RF=(A/weight of sample (mg)) (2)

% Fluroxypyr=((Sample RF/Standard RF)×P) (3)

In Formulas (1)-(3), S is the area of fluroxypyr in the standard solution, A is the area of fluroxypyr in the sample, RF is the response factor, and P is purity.

Dispersibility was calculated by dispersing the sample in water and inverting until complete dispersion was observed. A graduated cylinder was filled with 100 ml of standard 342 ppm water, and 0.3 grams of the sample was added to the cylinder, which was stoppered. The cylinder was turned 180 degrees allowing the air bubble to surface. The cylinder was then returned to the upright position, which completed one inversion cycle. Following the inversion cycle, the cylinder was held at 45 degrees to the line of sight and visually inspected for undispersed granules falling down the cylinder. The inversion cycle was repeated until all granules were dispersed (i.e., the granule is disintegrated but not necessarily to the point where nothing can be seen—rather, only to the point where there is no resemblance of a granule remaining in the cylinder). The number of cycles required for all particles to become dispersed was recorded as the dispersibility of the granules.

Suspensibility was calculated by suspending in standard hard water and allowing it to stand for 30 minutes. Ninety percent of the suspension was withdrawn and the remaining solution was filtered, dried, and the suspension was calculated.

More specifically, 1.0+/−0.01 g of sample was weighed into a 150 ml beaker containing approximately 50 ml of 342 ppm water and mixed. The entire sample was washed from the beaker into a 250 ml graduated cylinder using 342 ppm water and diluted to the full 250 ml using 342 ppm water. The cylinder was stoppered and slowly inverted and returned to the upright position for 30 cycles. The cylinder was allowed to stand undisturbed for 30 minutes, and 225 ml of the suspension was siphoned off using a vacuum pump.

A piece of filter paper was weighed and molded into a Buchner funnel using water. The Buchner funnel with filter paper was placed on a side arm flask, and the remaining suspension was washed into the filter paper using 342 ppm water. The filter paper was removed from the funnel and placed in an oven to dry at 50° C. The paper was removed from the oven when dry and allowed to sit at ambient conditions for 30 minutes. The weight was taken and used to calculate suspensibility as provided below.

Paper weight−Tare weight=residue weight (4)

((sample weight−residue weight)/sample weight)×100=% suspension (5)

### Example 3

### Effectiveness of Solid Formulation of Low Melting Active Compound

Since low melting active compounds have previously been difficult or impossible to formulate as a stable, solid composition, such low melting actives have previously been formulated as liquid compositions. For example, fluroxypyr-meptyl previously has been formulated as a liquid, emulsifiable concentrate composition, such as that marketed under the tradenames STARANE® and ATTAIN®. To illustrate that the herbicidal activity of the low melting active compound fluroxypyr-meptyl was not compromised by formulating as a solid composition according to the present invention, a solid fluroxypyr-meptyl composition according to the invention was tested along with known liquid fluroxypyr-meptyl compositions.

A 40% WDG fluroxypyr formulation, such as described in Example 1, was used alone or in combination with one or more of the following additives:
non-ionic surfactant (NIS) at 0.25% v/v or 0.5% v/v;
a basic blend (BB) of a NIS and a nitrogen source (1% v/v);
a tank mix of NIS and solid ammonium sulfate (0.5 kg);
crop oil concentrate (1% v/v); and
2,4-D ester herbicide with or without NIS.
   The additives were used to determine whether they had any effect on the usefulness of the solid fluroxypyr formulation. The herbicide 2,4-D is a common mixing partner with fluroxypyr, and the ester form was used particularly to determine whether the inherent adjuvant properties of the ester would increase the usefulness of the solid fluroxypyr formulation.

The 40% WDG fluroxypyr formulation was tank mixed with water (and the optional additive) and was applied at a rate of 70, 105, or 140 g ai/ha (2.5, 3.75, or 5.0 oz formulated product/acre). The liquid STARANE® or ATTAIN® (and any optional additive) was applied at a rate of 70 or 105 g ai/ha. The formulations were applied to test the ability to control weeds (kochia, buckwheat, thistle, or flax) around a wheat crop. For all applications, crop injury was evaluated to be less than 5%, indicating the solid formulation was safe for use on the crop.

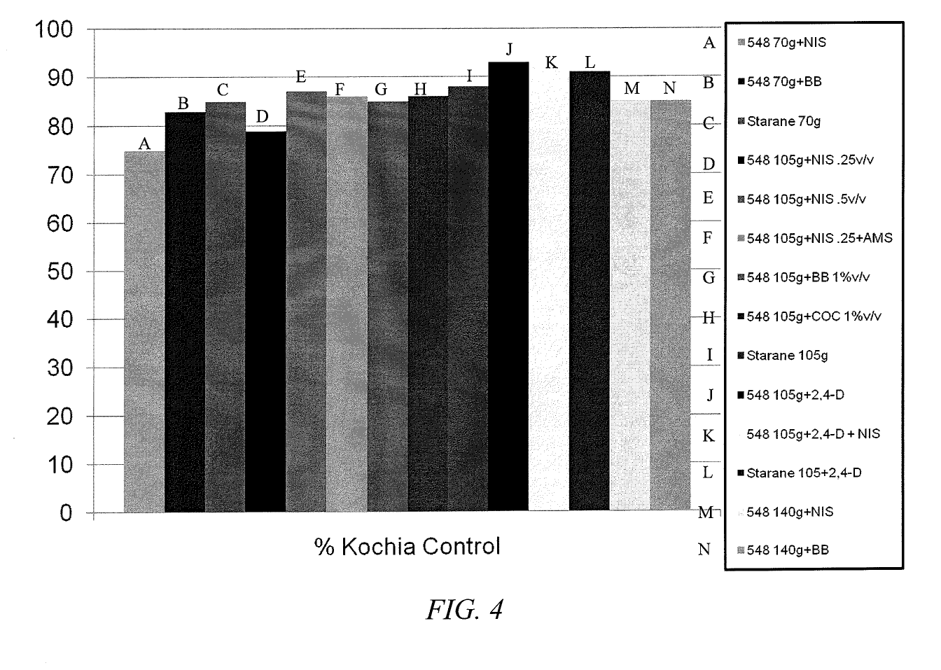

The percent weed control for each application with each of the four weed types is provided in FIG. 4 through FIG. 7. As illustrated in FIG. 4, the three STARANE® applications provided about 84-90% kochia control. Kochia control with the inventive 40% WDG fluroxypyr formulation ranged from about 75-93% depending upon the application rate and the adjuvant used. For all tests, the inventive 40% WDG fluroxypyr formulation performed equally as well as the liquid STARANE® formulation.

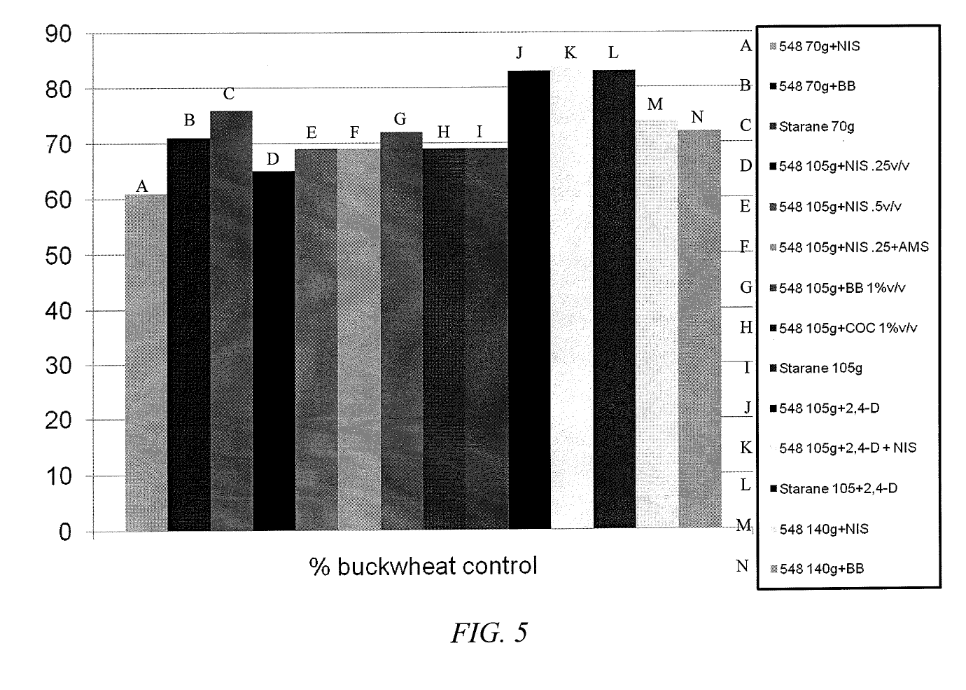

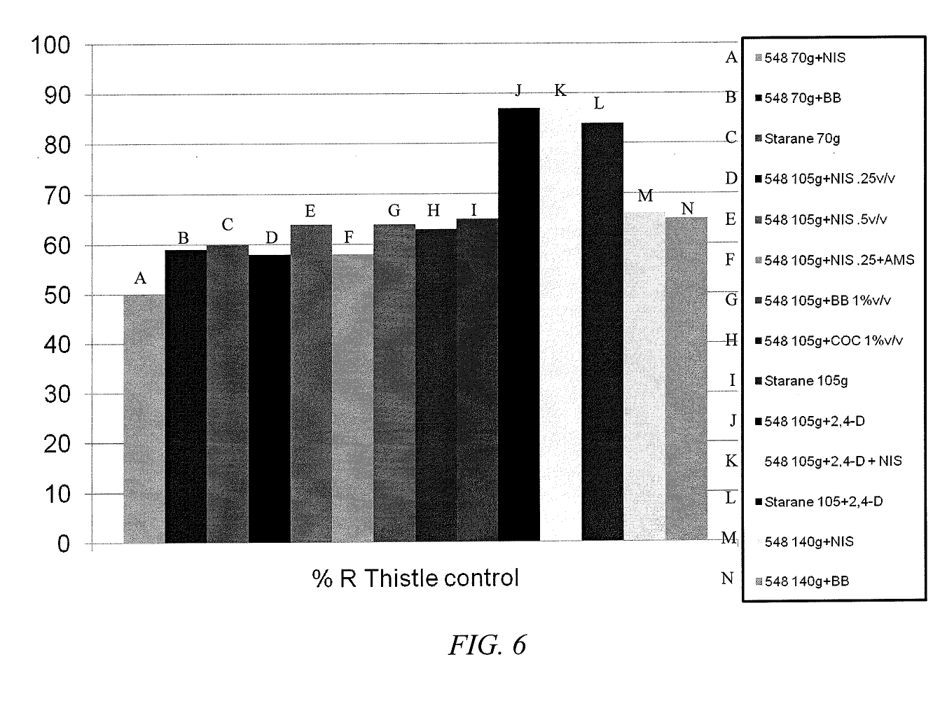

As seen in FIG. 5, the combination with 2,4-D provided a significant improvement in control of buckwheat for both the inventive 40% WDF fluroxypyr formulation and the liquid STARANE® formulation. Control rates for the inventive 40% WDG fluroxypyr formulation at a rate of 105 g ai/ha were substantially similar to the control rates of the liquid STARANE® formulation at the same application rate. Similar results are seen in FIG. 6 for control of thistle weed.

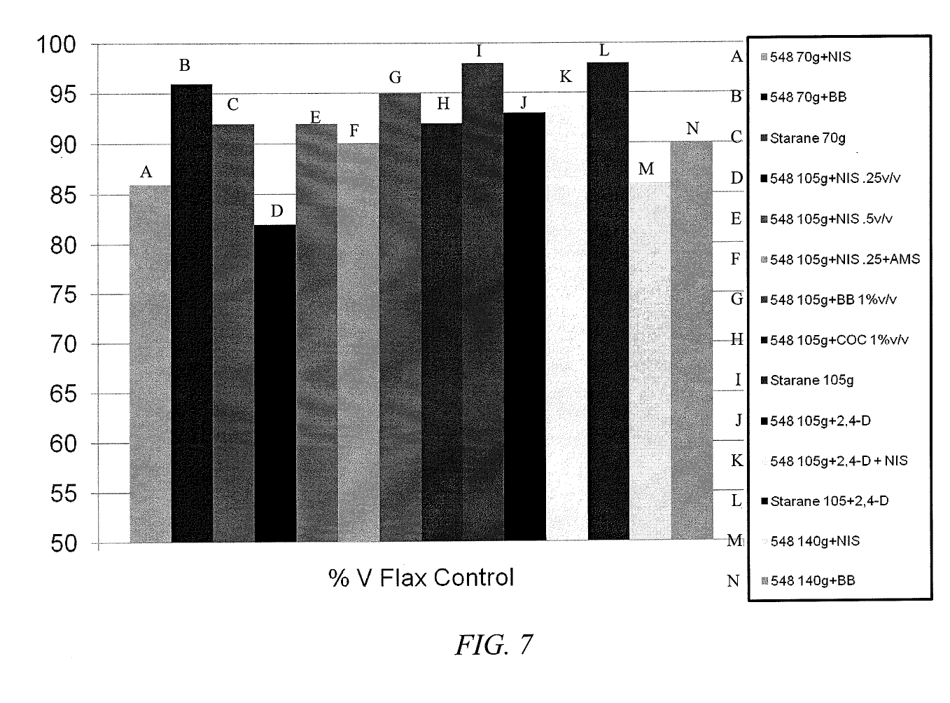

Flax weed control, illustrated in FIG. 7, appears to be somewhat more dependant upon the choice of adjuvant for the inventive 40% WDG fluroxypyr formulation. Nevertheless, the invention formulation still achieved control rates (around 85-95%) that were on par with the control rates provided by the liquid STARANE® formulation.

The testing illustrated that the inventive solid fluroxypyr formulation was responsive to the addition of various adjuvants. In particular, the addition of 2,4-D ester was found to enhance the activity of the fluroxypyr without the requirement of any further surfactant. Moreover, the inventive solid formulation was found to be more responsive to choice of adjuvant than to the application rate (i.e., similar control levels were achieved independent of application rate).

Many modifications and other embodiments of the invention set forth herein will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A solid formulation comprising:
a low melting active compound in particulate form;
a free-flow agent in particulate form; and
a solid diluent,
wherein particles of the low melting active compound are impregnated with the free-flow agent particles.

2. The solid formulation of claim 1, wherein the low melting compound is a pesticidally active compound.

3. The solid formulation of claim 2, wherein the pesticidally active compound is a herbicidally active compound.

4. The solid formulation of claim 3, wherein the herbicidally active compound is a fluroxypyr ester.

5. The solid formulation of claim 4, wherein the fluroxypyr ester is fluroxypyr-meptyl.

6. The solid formulation of claim 1, wherein the low melting active and the free-flow agent are present in a weight:weight ratio of about 7:1 to about 3:1.

7. The solid formulation of claim 1, comprising about 2% to about 15% by weight of the free-flow agent.

8. The solid formulation of claim 1, comprising about 10% by weight to about 70% by weight of the low melting active compound.

9. The solid formulation of claim 1, comprising about 10% by weight to about 80% by weight of the solid diluent.

10. The solid formulation of claim 1, wherein the free-flow agent comprises a silica-containing material.

11. The solid formulation of claim 10, wherein the free-flow agent comprises hydrophobic silicon dioxide.

12. The solid formulation of claim 1, further comprising a pH adjuster in an amount sufficient to maintain the pH of the formulation when it is in a water diluted form below about 7.

13. The solid formulation of claim 12, comprising about 0.1% by weight to about 2% by weight of the pH adjuster.

14. The solid formulation of claim 1, further comprising a binding agent.

15. The solid formulation of claim 14, comprising at least about 4% by weight of the binding agent.

16. The solid formulation of claim 1, comprising one or more adjuvants selected from the group consisting of dispersants, wetting agents, binding agents, and anti-foam agents.

17. The solid formulation of claim 1, wherein the solid formulation is in the form of a granule.

18. The solid formulation of claim 1, further comprising one or more additional active compounds.

19. The solid formulation of claim 18, wherein the one or more additional active compounds is a pesticidally active compound.

20. The solid formulation of claim 1, wherein the solid formulation has a moisture content of less than about 5% by weight.

21. A mixture comprising two or more groups of different solid pesticidal granules, wherein one of the groups comprises a solid composition according to claim 1.

22. A method of controlling an unwanted pest at a locus comprising applying to the locus a solid formulation according to claim 1, wherein the low melting active compound is a pesticidally active compound.

23. A solid formulation comprising:
(a) about 10% by weight to about 70% by weight of a low melting active compound;
(b) about 2% by weight to about 15% by weight of a free-flow agent;
(c) about 10% by weight to about 80% by weight of a diluent;
(d) about 2% by weight to about 25% by weight of a dispersant;
(e) about 1% by weight to about 15% by weight of a binding agent;
(f) about 0.1% by weight to about 5% by weight of a pH adjuster;
(g) up to about 5% by weight of a wetting agent; and
(h) up to about 5% by weight of an anti-foam agent;
wherein the solid formulation is in the form of a granule having a moisture content of less than about 5% by weight.

24. The solid formulation of claim 23, wherein the low melting active compound is in particulate form.

25. The solid formulation of claim 24, wherein the free-flow agent is in particulate form, and wherein particles of the low melting active compound are impregnated with the free-flow agent particles.

26. The solid formulation of claim 24, wherein the low melting active compound comprises fluroxypyr-meptyl.

27. A method of preparing a solid formulation comprising a low melting active compound, the method comprising:
a) mixing the low melting active compound in particulate form with a free-flow agent in particulate form under high shear or impact to impregnate particles of the low melting active compound with the particles of the free-flow agent to form bound particles of the low melting active compound and the free-flow agent;
b) combining the bound particles of the low melting active compound and the free-flow agent with a diluent and one or more formulation adjuvants to form a homogeneous mixture; and
c) milling the homogeneous mixture to form particles.

28. The method of claim 27, wherein said mixing step a) comprises blending the low melting active and the free-flow agent and feeding the blended material through a mill apparatus.

29. The method of claim 28, wherein the mill apparatus comprises a hammer mill.

30. The method of claim 7, wherein the free-flow agent comprises a silica-containing material.

31. The method of claim 30, wherein the free-flow agent comprises hydrophobic silicon dioxide.

32. The method of claim 27, wherein the low melting active and the free-flow agent are bound in a weight:weight ratio of about 7:1 to about 3:1.

33. The method of claim 27, wherein the entire content of the free-flow agent used in preparing the solid formulation is provided in said mixing step a).

34. The method of claim 27, wherein the free-flow agent comprises about 2% to about 15% by weight of the solid formulation.

35. The method of claim 27, wherein the low melting compound is a pesticidally active compound.

36. The method of claim 35, wherein the pesticidally active compound is a herbicidally active compound.

37. The method of claim 36 wherein the herbicidally active compound is a fluroxypyr ester.

38. The method of claim 37, wherein the fluroxypyr ester is fluroxypyr-meptyl.

39. The method of claim 27, wherein the one or more formulation adjuvants are selected from the group consisting of dispersants, binding agents, pH adjusters, and wetting agents.

40. The method of claim 27, wherein said milling step c) comprises formation of particles having an average size of about 1 micron to about 15 microns.

41. The method of claim 27, wherein said milling step c) comprising high energy milling.

42. The method of claim 27, further comprising processing the particles to be in a solid delivery form

43. The method of claim 42, wherein said further processing step comprises adding an anti-foam agent to the formulation.

44. The method of claim 42, wherein said further processing step comprises shaping the mix to form a granule, pill, prill, pellet, or powder.

45. The method of claim 44, wherein the solid formulation is in the form of granules having an average size of about 0.1 mm to about 10 mm.

46. The method of claim 27, wherein the formed solid formulation is dried to have an average moisture content of less than about 5% by weight.

47. A method of preparing a solid formulation comprising a low melting active compound, the method comprising:
a) mixing about 10% by weight to about 70% by weight of the low melting active compound in particulate form with about 2% by weight to about 15% by weight of a free-flow agent in particulate form under high shear or impact to impregnate particles of the low melting active compound with the particles of the free-flow agent to form bound particles of the low melting active compound and the free-flow agent;
b) combining the bound particles of the low melting active compound and the free-flow agent with about 10% by weight to about 80% by weight of a diluent, about 2% by weight to about 25% by weight of a dispersant, about 1% by weight to about 15% by weight of a binding agent, about 0.1% by weight to about 5% by weight of a pH adjuster, and up to about 5% by weight of a wetting agent to form a homogeneous mixture;
c) milling the homogeneous mixture to form particles; and
d) further processing the particles with up to about 5% by weight of an anti-foam agent to be in a solid delivery form;
wherein all of the percentages are based on the final weight of the overall solid formulation.
